(19) United States
(12) Patent Application Publication
(10) Pub. No.: US 2024/0428021 A1
(43) Pub. Date: Dec. 26, 2024

(54) DISPLAY APPARATUS, DISPLAY SYSTEM, DISPLAY METHOD, AND RECORDING MEDIUM

(71) Applicant: Chika NAKANO, Osaka (JP)

(72) Inventor: Chika NAKANO, Osaka (JP)

(21) Appl. No.: 18/281,320

(22) PCT Filed: Jan. 18, 2022
(86) PCT No.: PCT/IB2022/050368

§ 371 Date: Sep. 11, 2023

(30) Foreign Application Priority Data
Mar. 15, 2021 (JP) 2021-041593

(51) Int. Cl. G06F 40/58; G06F 3/04842; G06F 3/04883; G06F 40/247; G06V 30/10

(52) U.S. Cl. CPC G06F 40/58; G06F 3/04842; G06F 3/04883; G06F 40/247; G06V 30/10

(57) ABSTRACT

A display apparatus includes a receiving unit to receive input of handwritten data on a screen, and a display control unit. The display control unit simultaneously displays, on a display, a plurality of character strings in different languages that are synonymous with a character string converted from the handwritten data.

### TECHNICAL FIELD

Embodiments of the present disclosure relate to a display apparatus, a display system, a display method, and a recording medium.

### BACKGROUND ART

There are display apparatuses that convert handwriting input into a text and displays the text on a screen by using a handwriting recognition technique. A display apparatus having a relatively large touch panel is used in a conference room or the like, and is shared by a plurality of users as an electronic whiteboard or the like. In some cases, a display apparatus is used as a written communication tool.

In addition, there is a technology of converting handwriting into a text of another language using a handwriting recognition technology (for example, PTL 1). PTL 1 discloses a technology of performing character recognition on handwriting to convert the handwriting into a text, and further converting the text into a text of different language.

### CITATION LIST

### Patent Literature

### [PTL 1]

Japanese Unexamined Patent Application Publication No. 2003-162527

### SUMMARY OF INVENTION

### Technical Problem

In the related art, a character string of a certain language converted from one input handwritten data is displayed. However, a display apparatus may be used in a workplace or a site where different language speakers are mixed. In such a situation, it is desired to display respective character strings of a plurality of different languages converted from one handwritten data of a certain language.

In view of the above inconvenience, an object of the present disclosure is to provide a display apparatus that displays multiple character strings in different languages converted from input handwritten data.

### Solution to Problem

An embodiment provides a display apparatus that includes a receiving unit to receive input of handwritten data on a screen; and a display control unit to simultaneously display, on a display, a plurality of character strings in different languages synonymous with a character string converted from the handwritten data.

Another embodiment provides a display system that includes the above-described display apparatus; and a conversion unit to obtain, based on a synonym dictionary, a plurality of character strings in different languages synonymous with a character string converted from the handwritten data.

Another embodiment provides a display system that includes a receiving unit to receive input of handwritten data on a screen; a conversion unit to determine, based on a synonym dictionary, a plurality of character strings in different languages synonymous with a character string converted from the handwritten data; and a display control unit to display the plurality of character strings in different languages.

Another embodiment provides a display method includes receiving input of handwritten data; and displaying a plurality of character strings in different languages synonymous with a character string converted from the handwritten data.

Another embodiment provides a recording medium storing a plurality of instructions which, when executed by one or more processors, cause the processors to perform the above-described.

### Advantageous Effects of Invention

According to one embodiment of the present disclosure, the display apparatus displays multiple character strings in different languages converted from input handwritten data.

### BRIEF DESCRIPTION OF DRAWINGS

The accompanying drawings are intended to depict example embodiments of the present invention and should not be interpreted to limit the scope thereof. The accompanying drawings are not to be considered as drawn to scale unless explicitly noted. Also, identical or similar reference numerals designate identical or similar components throughout the several views.

FIG. 1 is a diagram illustrating an overview of language conversion by a display apparatus according to embodiments of the present disclosure.

FIG. 2A is a diagram illustrating an example of a general arrangement of the display apparatus according to embodiments.

FIG. 2B is a diagram illustrating another example of the display apparatus illustrated in FIG. 2A.

FIG. 2C is a diagram illustrating yet another example of the display apparatus another example of the display apparatus illustrated in FIG. 2A.

FIG. 3 is a block diagram illustrating an example of a hardware configuration of the display apparatus according to embodiments.

FIG. 4 is a block diagram illustrating an example of a functional configuration of the display apparatus according to Embodiment 1.

FIG. 5 is a diagram illustrating an example of an operation guide and selectable character string candidates provided by the display apparatus according to Embodiment 1.

FIG. 6 is a diagram illustrating a first example of conversion of handwritten data in a case in which target language is not fixed.

FIG. 7 is a flowchart illustrating an example of process of the conversion illustrated in FIG. 6.

FIG. 8 is a diagram illustrating a second example of conversion of handwritten data in the case in which target language is not fixed.

FIG. 9 is a flowchart illustrating an example of process of the conversion illustrated in FIG. 8.

FIG. 10 is a block diagram illustrating a functional configuration of the display apparatus according to Embodiment 2.

FIG. 11 is a diagram illustrating a first example of conversion of handwritten data performed by the display apparatus according to Embodiment 2, in a case in which target language is fixed.

FIG. 12 is a flowchart illustrating an example of process of the conversion illustrated in FIG. 11.

FIG. 13 is a diagram illustrating a second example of conversion of handwritten data performed by the display apparatus according to Embodiment 2, in the case in which target language is fixed.

FIG. 14 is a flowchart illustrating an example of process of the conversion illustrated in FIG. 13.

FIG. 15 is a diagram illustrating a third example of conversion of handwritten data performed by the display apparatus according to Embodiment 2, in the case in which target language is fixed.

FIG. 16 is a flowchart illustrating an example of process of the conversion illustrated in FIG. 15.

FIG. 17 illustrates an example of icon buttons for setting a target language.

FIG. 18 is a flowchart illustrating an example of process of the conversion illustrated in FIG. 17.

FIG. 19 illustrates example of displaying a source language and a target language by a display apparatus according to Embodiment 3.

FIG. 20 is a diagram illustrating an example of conversion into English and Chinese by the display apparatus according to Embodiment 3.

FIG. 21 is a diagram illustrating another example of conversion into English and Chinese by the display apparatus according to Embodiment 3.

FIG. 22 is a flowchart illustrating an example of process of the conversion illustrated in FIG. 21.

FIG. 23 is a diagram illustrating a recommendation window additionally displayed from an operation guide provided by the display apparatus according to Embodiment 3.

FIG. 24 is a diagram illustrating an example of an operation guide on which displayed electable character string candidates flow (like a telop) in a manner similar to a digital signage, according to Embodiment 3.

FIG. 25 is a diagram illustrating a configuration of a display system according to Embodiment 4.

FIG. 26 is a diagram illustrating a configuration of a display system according to Embodiment 5.

FIG. 27 is a diagram illustrating a configuration of a display system according to Embodiment 6.

FIG. 28 is a diagram illustrating a configuration of a display system according to Embodiment 7.

### DESCRIPTION OF EMBODIMENTS

The terminology used herein is for the purpose of describing particular embodiments only and is not intended to be limiting of the present invention. As used herein, the singular forms “a,” “an,” and “the” are intended to include the plural forms as well, unless the context clearly indicates otherwise.

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

A description is given below of a display apparatus and a display method performed by the display apparatus according to embodiments of the present disclosure, with reference to the attached drawings.

### Embodiment 1

A display apparatus may be used in a workplace or a site where different language speakers are mixed. In such a situation, when a first person who speaks a certain language (first language) wants to convey, by handwriting, information to a second person who speaks a different language (second language), the communication is facilitated by converting and displaying the character string displayed on the display into the second language understood by the second person. However, the first person may not understand well the second language. In addition, the first person may not know which language the second person understand.

### Outline of Conversion of Character String

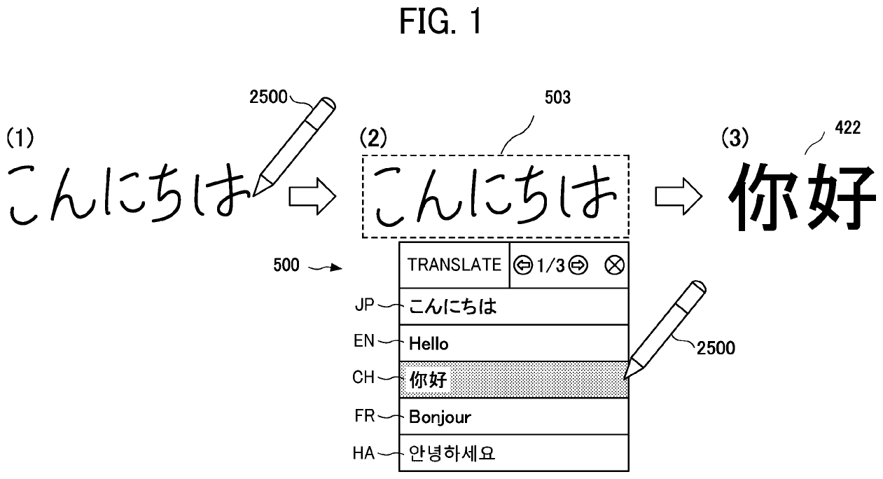

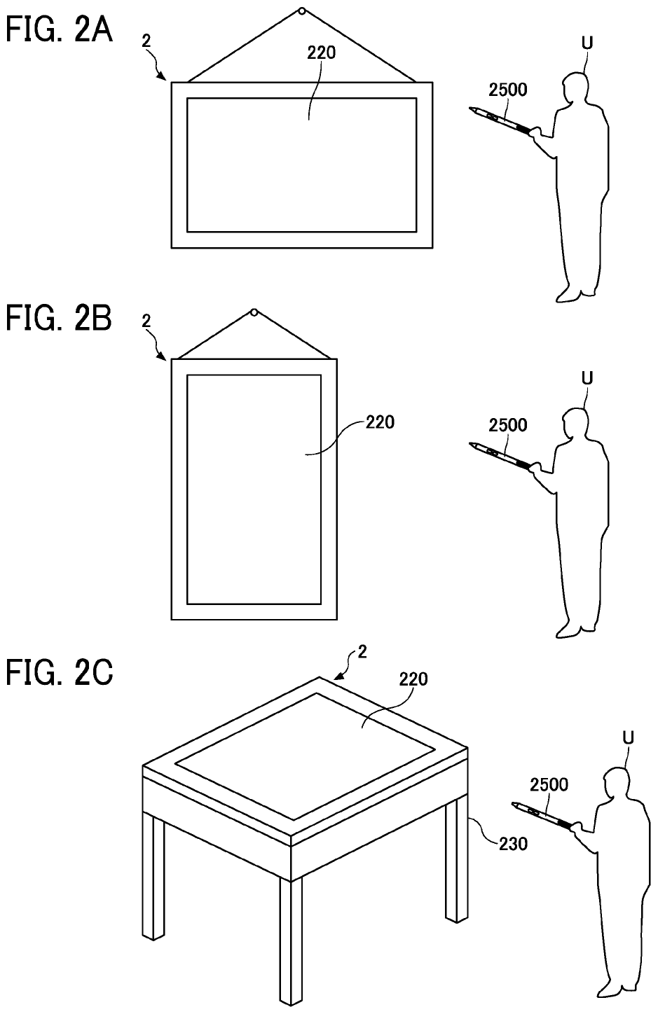

FIG. 1 is a diagram illustrating an overview of language conversion by, for example, a display apparatus 2 illustrated in FIG. 2 according to the present embodiment.
(1) First, a user handwrites a Japanese word “ [symbol] ” meaning “hello,” for example, with a pen 2500. The user does not necessarily have to handwrite the entire “ [symbol] ”
(2) The display apparatus 2 displays a handwritten data rectangular area 503 including the handwriting (an object displayed based on stroke data) and converts the handwriting into a character string JP ( [symbol] ) by character recognition. Further, the display apparatus 2 displays an operation guide 500 including a list of character strings in different language synonymous with “hello.” In FIG. 1, English, Chinese, French, and Korean character strings EN, CH, FR, and HA (character string candidates) synonymous with “hello” are displayed. The term “different language” refers to a language other than the language of the character string recognized from the handwritten data.
(3) When the user who wants to convert the recognized character string into, for example, Chinese, selects the character string CH on the operation guide 500, the display apparatus 2 displays a Chinese character string 422 on the screen.

As described above, even without preliminary setting by the user of a conversion target language (hereinafter simply “target language”) to which the character string is to be converted, the display apparatus 2 according to the present embodiment displays a list of character strings having the same meaning in different languages from the language input by handwriting. Therefore, different language speakers can communicate with each other even when the first language speaker does not fully understand the second language, or even when the first language speaker does not know what language the second person understands.

Note that, there is a conventional technology of a database (a computer) that defines relations between Japanese words and English words, data related with each other are collected and organized into a data structure having a relation to facilitate retrieval and update, but such a database is handled as a different database from another database that defines relations between Japanese words and Chinese words. Therefore, before inputting handwriting, the user designates a target language (English or Chinese in the above example) in order to identify the database to be used.

Therefore, the conventional technology requires setting by the user of the target language before input of the handwriting to be converted.

### Terms

“Input device” may be any means capable of handwriting by designating coordinates on a touch panel. Examples thereof include a pen, a human finger, a human hand, and a bar-shaped member.

A series of user operations including engaging a writing mode, recording movement of an input device or portion of a user, and then disengaging the writing mode is referred to as a stroke. The engaging of the writing mode may include, if desired, pressing an input device against a display or screen, and disengaging the writing mode may include releasing the input device from the display or screen. Alternatively, a stroke includes tracking movement of the portion of the user without contacting a display or screen. In this case, the writing mode may be engaged or turned on by a gesture of a user, pressing a button by a hand or a foot of the user, or otherwise turning on the writing mode, for example using a pointing device such as a mouse. The disengaging of the writing mode can be accomplished by the same or different gesture used to engage the writing mode, releasing the button, or otherwise turning off the writing mode, for example using the pointing device or mouse.

“Stroke data” is data based on a trajectory of coordinates of a stroke input with the input device, and the coordinates may be interpolated appropriately.

“Handwritten data” is represented by one or more stroke data. “Handwriting input” represents input of handwritten data by the user.

An “object” refers to an item displayed on a display.” The term “object” in this specification represents an object of display.

Examples of “character string,” converted from handwritten data by character recognition, include, in addition to texts, a stamp of a given character or mark such as “complete,” a graphic such as a circle or a star, or a line.

“Confirmed data” refers to one or more character codes (font) converted from handwritten data by character recognition and selected by the user, or handwritten data that is determined not to be converted into one or more character codes (font).

An “operation command” refers to a command prepared for instructing a handwriting input device to execute a specific process. In the present embodiment, operation command examples include commands for the user to instructs the display apparatus 2 to rotate the entire image and to associate the display direction with a converted character string in the target language. Operation command examples further include commands for editing, modifying, inputting, or outputting a character string.

The character string includes one or more characters handled by a computer. The character string actually is one or more character codes. Characters include numbers, alphabets, symbols, and the like. The character string is also referred to as text data.

Conversion refers to an act of changing or being changed. Converting the language of a character string may be referred to as translation.

### Configuration of Apparatus

Referring to FIGS. 2A to 2C, a description is given of a general arrangement of the display apparatus 2 according to the present embodiment. FIGS. 2A to 2C are diagrams illustrating examples of general arrangement of the display apparatus 2. FIG. 2A illustrates, as an example of the display apparatus 2, an electronic whiteboard having a landscape-oriented rectangular shape and being hung on a wall.

As illustrated in FIG. 2A, the display apparatus 2 includes a display 220 (a screen). A user U handwrites (inputs or draws), for example, a character on the display 220 using the pen 2500 including a communication circuit.

FIG. 2B illustrates, as another example of the display apparatus 2, an electronic whiteboard having a portrait-oriented rectangular shape and being hung on a wall.

FIG. 2C illustrates, as another example, the display apparatus 2 placed on the top of a desk 230. The display apparatus 2 has a thickness of about 1 centimeter. It is not necessary to adjust the height of the desk 230, which is a general-purpose desk, when the display apparatus 2 is placed on the top of the desk 230. Further, the display apparatus 2 is portable and easily moved by the user.

Examples of an input method of coordinates by the pen 2500 include an electromagnetic induction method and an active electrostatic coupling method. In other example, the pen 2500 further has functions such as pen pressure detection, inclination detection, a hover function (displaying a cursor before the pen is brought into contact), or the like.

### Hardware Configuration

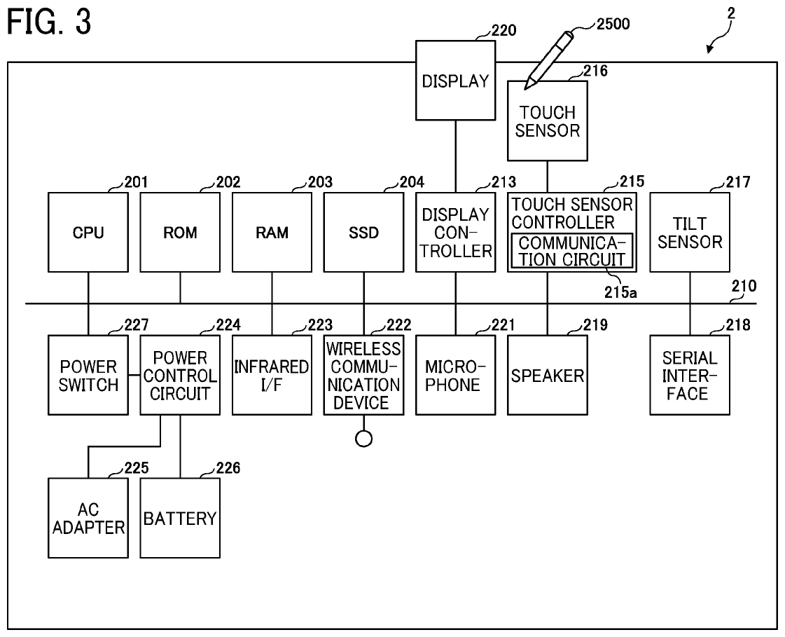

A description is given of a hardware configuration of the display apparatus 2 according to the present embodiment, with reference to FIG. 3. The display apparatus 2 has a configuration similar to that of an information processing apparatus or a general-purpose computer as illustrated in FIG. 3. FIG. 3 is a block diagram illustrating an example of the hardware configuration of the display apparatus 2. As illustrated in FIG. 3, the display apparatus 2 includes a central processing unit (CPU) 201, a read only memory (ROM) 202, a random access memory (RAM) 203, and a solid state drive (SSD) 204.

The CPU 201 controls entire operation of the display apparatus 2. The ROM 202 stores a control program such as an initial program loader (IPL) to boot the CPU 201. The RAM 203 is used as a work area for the CPU 201.

The SSD 204 stores various data such as an operating system (OS) and a control program for display apparatuses. This program may be an application program that runs on an information processing apparatus equipped with a general-purpose operating system (OS) such as WINDOWS, MAC OS, ANDROID, and IOS.

The display apparatus 2 further includes a display controller 213, a touch sensor controller 215, a touch sensor 216, a display 220, a power switch 227, a tilt sensor 217, a serial interface 218, a speaker 219, a microphone 221, a wireless communication device 222, an infrared interface (I/F) 223, a power control circuit 224, an AC adapter 225, and a battery 226.

The display controller 213 controls display of an image for output to the display 220, etc. The touch sensor 216 detects that the pen 2500, a user's hand or the like is brought into contact with the display 220. The pen or the user's hand is an example of input device. The touch sensor 216 also receives a pen identifier (ID).

The touch sensor controller 215 controls processing of the touch sensor 216. The touch sensor 216 performs coordinate input and coordinate detection. More specifically, in a case where the touch sensor 216 is optical type, the display 220 is provided with two light receiving and emitting devices disposed on both upper side ends of the display 220, and a reflector frame surrounding the sides of the display 220. The light receiving and emitting devices emit a plurality of infrared rays in parallel to a surface of the display 220. Light-receiving elements receive lights passing in the direction that is the same as an optical path of the emitted infrared rays, which are reflected by the reflector frame. The touch sensor 216 outputs position information of the infrared ray that is blocked by an object after being emitted from the two light receiving and emitting devices, to the touch sensor controller 215. Based on the position information of the infrared ray, the touch sensor controller 215 detects a specific coordinate that is touched by the object. The touch sensor controller 215 further includes a communication circuit 215a for wireless communication with the pen 2500. For example, when communication is performed in compliance with a standard such as BLUETOOTH (registered trademark), a commercially available pen can be used. When one or more pens 2500 are registered in the communication circuit 215a in advance, the display apparatus 2 communicates with the pen 2500 without connection setting between the pen 2500 and the display apparatus 2, performed by the user.

The power switch 227 turns on or off the power of the display apparatus 2. The tilt sensor 217 detects the tilt angle of the display apparatus 2. The tilt sensor 217 is mainly used to detect whether the display apparatus 2 is being used in any of the states in FIG. 2A, 2B, or 2C. For example, the display apparatus 2 automatically changes the thickness of characters or the like depending on the detected state.

The serial interface 218 is a communication interface to connect the display apparatus 2 to extraneous sources such as a universal serial bus (USB). The serial interface 218 is used to input information from extraneous sources. The speaker 219 is used to output sound, and the microphone 221 is used to input sound. The wireless communication device 222 communicates with a terminal carried by the user and relays the connection to the Internet, for example. The wireless communication device 222 performs communication in compliance with Wi-Fi, BLUETOOTH (registered trademark) or the like. Any suitable standard can be applied other than the Wi-Fi and BLUETOOTH (registered trademark). The wireless communication device 222 forms an access point. When a user sets a service set identifier (SSID) and a password that the user obtains in advance in the terminal carried by the user, the terminal is connected to the access point.

It is preferable that two access points are provided for the wireless communication device 222 as follows:
(a) Access point to the Internet; and
(b) Access point to Intra-company network to the Internet.

The access point (a) is for users other than, for example, company staffs. The access point (a) does not allow access from such users to the intra-company network, but allow access to the Internet. The access point (b) is for intra-company users and allows such users to access the intra-company network and the Internet.

The infrared I/F 223 detects an adjacent display apparatus 2. The infrared I/F 223 detects an adjacent display apparatus 2 using the straightness of infrared rays. Preferably, one infrared I/F 223 is provided on each side of the display apparatus 2. This configuration allows the display apparatus 2 to detect the direction in which the adjacent display apparatus 2 is disposed. Such arrangement extends the screen. Accordingly, the user can instruct the adjacent display apparatus 2 to display a previous handwritten object. That is, one display 220 (screen) corresponds to one page, and the adjacent display 220 displays the handwritten object on a separate page.

The power control circuit 224 controls the AC adapter 225 and the battery 226, which are power supplies for the display apparatus 2. The AC adapter 225 converts alternating current shared by a commercial power supply into direct current.

In a case where the display 220 is a so-called electronic paper, the display 220 consumes little or no power to maintain image display. In such case, the display apparatus 2 may be driven by the battery 226. With this structure, the display apparatus 2 is usable as, for example, a digital signage in places such as outdoors where power supply connection is not easy.

The display apparatus 2 further includes a bus line 210. The bus line 210 is an address bus or a data bus that electrically connects the elements illustrated in FIG. 3, such as the CPU 201, to each other.

The touch sensor 216 is not limited to the optical type. In another example, the touch sensor 216 is a different type of detector, such as a capacitance touch panel that identifies the contact position by detecting a change in capacitance, a resistance film touch panel that identifies the contact position by detecting a change in voltage of two opposed resistance films, or an electromagnetic induction touch panel that identifies the contact position by detecting electromagnetic induction caused by contact of an object to a display. The touch sensor 216 can be of a type that does not require an electronic pen to detect whether the pen tip is in contact with the surface of the display 220. In this case, a fingertip or a pen-shaped stick is used for touch operation. In addition, the pen 2500 can have any suitable shape other than a slim pen shape.

### Functions

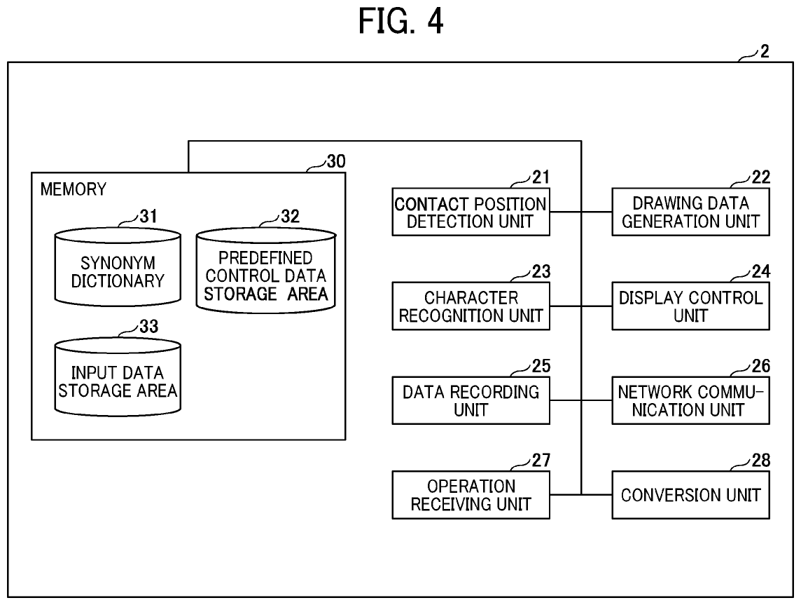

A description is now given of a functional configuration of the display apparatus 2 according to the present embodiment, with reference to FIG. 4. FIG. 4 is a block diagram illustrating an example of the functional configuration of the display apparatus 2 according to the present embodiment. The display apparatus 2 includes a contact position detection unit 21, a drawing data generation unit 22, a character recognition unit 23, a display control unit 24, a data recording unit 25, a network communication unit 26, an operation receiving unit 27, and a conversion unit 28. The functional units of the display apparatus 2 are implemented by or are caused to function by operation of any of the elements illustrated in FIG. 3 according to an instruction from the CPU 201 according to a program loaded from the SSD 204 to the RAM 203.

The contact position detection unit 21 is implemented by the touch sensor 216 and detects coordinates of the position touched by the pen 2500. The drawing data generation unit 22 acquires the coordinates (i.e., contact coordinates) of the position touched by the pen tip of the pen 2500 from the contact position detection unit 21. The drawing data generation unit 22 connects a plurality of contact coordinates into a coordinate point sequence by interpolation, to generate stroke data.

The character recognition unit 23 performs character recognition processing on one or more stroke data (handwritten data) input by the user and converts the stroke data into one or more character codes. The character recognition unit 23 reads characters (of multilingual languages such as English as well as Japanese), numbers, symbols (e.g., %, $, and &), graphics (e.g., lines, circles, and triangles) concurrently with a pen operation by the user. Although various algorithms have been proposed for the recognition method, a detailed description is omitted on the assumption that known techniques are used in the present embodiment.

The display control unit 24 displays, on a display, handwritten data, a character string converted from the handwritten data, and an operation menu to be operated by the user. The data recording unit 25 stores handwritten data input on the display apparatus 2, a converted character string, a screenshot on a personal computer (PC) screen, a file, and the like in a memory 30. The network communication unit 26 connects to a network such as a local area network (LAN), and transmits and receives data to and from other devices via the network.

The conversion unit 28 converts a character string input by the user into a character string of another language having the same meaning as the input character string, referring to a predefined control data storage area 32 and a synonym dictionary 31.

The display apparatus 2 includes the memory 30 implemented by, for example, the SSD 204 or the RAM 203 illustrated in FIG. 3. The memory 30 includes the synonym dictionary 31, the predefined control data storage area 32, and the input data storage area 33.

TABLE 1

| | language | | | | |
|---|---|---|---|---|---|
| meaning | Japanese | English | Chinese | French | Korean |
| Hello | [symbol] | Hello | [symbol] | Bonjour | [symbol] |
| Thanks | [symbol] | Thanks | [symbol] | Merci | [symbol] |

Table 1 schematically presents an example of contents of the synonym dictionary 31. The synonym dictionary 31 is a dictionary in which a plurality of different language synonyms is registered in association with each other. Synonyms refer to words that differ in pronunciation, notation, or the like but have the same meaning. Also referred to as equivalents. The conversion unit 28 converts the handwritten data into a plurality of character strings in different languages having the same meaning by referring to the synonym dictionary.

TABLE 2

| | |
|---|---|
| Predefined control item | Predefined control data |

| | | |
|---|---|---|
| Text language 361 | English | Language = “English” |
| | Chinese | Language = “Chinese” |
| | Korean | Language = “Korean” |
| Text meaning 362 | Hello | Textmeaning = “hello” |
| | Thanks | Textmeaning = “thanks” |

Table 2 schematically presents the predefined control data stored in the predefined control data storage area 32. The predefined control data is a control content of the display apparatus 2 based on the input character string. For example, predefined control data for a predefined control item “text language” 361 represents setting a language attribute corresponding to the language input by handwriting by the user. The language attribute indicates a language into which the conversion unit 28 converts the character string recognized from handwritten data. For example, when the user handwrites “English,” “English” is set as the language attribute. The handwritten data input by handwritten by the user is converted into English.

Predefined control data for the predefined control item “text meaning” 362 represents setting a Textmeaning attribute corresponding to the character string input by the user. The Textmeaning attribute represents a general meaning of the input character string. This meaning is used to search the synonym dictionary 31.

TABLE 3

| | Handwriting input stored data example |
|---|---|
| Input data 363 | DataId=“1” Type=“Text” Penid=“3” |
| | ColorId=“Blue” Angle=“270 dig” |
| | StartPoint=“x1,y1” |
| | StartTime=“yyyy-mm-ddThh:mm:ss.sss+09:00” |
| | EndPoint=“xn,yn” |
| | EndTime=“yyyy-mm-ddThh:mm:ss.sss+09:00” |
| | FontName=“ [symbol] ” FontSize=“10.0 pt” |
| | Text=“ [symbol] ” |
| | meaning=“hello” Language=“Japanese” |
| Input data 364 | DataId=“2” Type=“Text” Penid=“3” |
| | ColorId=“Black Angle=“0 dig” |
| | StartPoint=“x1,y1” |
| | StartTime=“yyyy-mm-ddThh:mm:ss.sss+09:00” |
| | EndPoint=“xn,yn” |
| | EndTime=“yyyy-mm-ddThh:mm:ss.sss+09:00” |
| | FontName=“ [symbol] ” FontSize=“50.0 pt” |
| | Text=“ [symbol] ” meaning=“hello” |
| | Language=“Chinese” |

Table 3 schematically presents contents of the input data storage area 33. The input data indicates an attribute of data input by a user for each data. Input data is recorded for each object (one stroke data, one character string, one image, or the like). Each of input data 363 and 364 is one object. Each attribute is described.

“DataId” is information identifying the input data.

“Type” represents the type of input data and includes stroke, text, and image. The attribute held by the input data may be different depending on type. In Table 3, a description is given of a case where the “type” is “text.” The text represents a character string, and the image is an image.

“PenId” is information identifying the pen 2500 used to input a character string.

“ColorId” is information identifying a color of a character string.

“Angle” is the display direction of a character string.

“StartPoint” is the coordinates of the upper left apex of the circumscribed rectangle of a character string.

“StartTime is the time of start of writing a character string by the user.

“EndPoint” is the coordinates of the lower right apex of the circumscribed rectangle of a character string.

“EndTime” is a time when the user has finished writing the character string.

“FontName” is the font name of the character string.

“FontSize” is the character size.

“Text” is an input text (character code).

“Meaning” represent the meaning of a character string.

“Language” is the language of character strings.

The input data 363 in Table 3 is data of input Japanese word meaning hello, and the input data 364 is data of input Chinese word meaning hello. The meaning attribute and the language attribute are specified by the predefined control data.

### Example of Display of Selectable Candidates

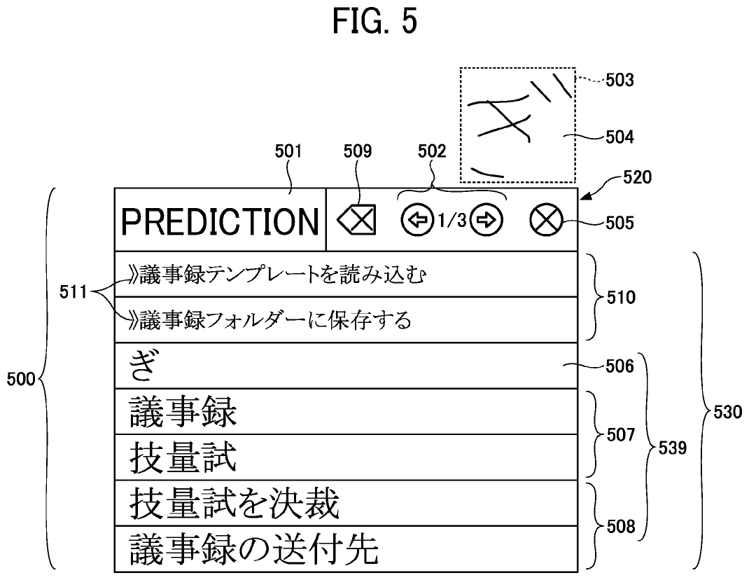

Next, with reference to FIG. 5, a description is given of the operation guide 500 displayed at the time of converting handwritten data. FIG. 5 illustrates an example of the operation guide 500 and selectable candidates 530 displayed by the operation guide 500. The operation guide 500 is displayed in response to input of handwritten data 504 by the user. The operation guide 500 displays a handwriting-recognition character string candidate 506, converted character string candidates 507, predicted converted-character string candidates 508, and operation command candidates 510. The selectable candidates 530 includes the handwriting-recognition character string candidate 506, the converted character string candidates 507, the predicted converted-character string candidates 508, and the operation command candidate 510. The selectable candidates 530 other than the operation command candidates 510 are referred to as character string candidates 539.

The handwritten data 504 is a character “ [symbol] ” (Japanese hiragana character, pronounced as “gi”) handwritten by the user. The display apparatus 2 displays the handwritten data rectangular area 503 including the handwritten data 504. In the example illustrated in FIG. 5, the operation guide 500 is displayed in response to input of one character as an example, but the time of display thereof is not limited thereto. The operation guide 500 is displayed in response to suspension of handwriting by the user. Therefore, the number of characters of the handwritten data 504 is arbitrary.

The respective character string candidates of the handwriting-recognition character string candidate 506, the converted character string candidates 507, and the predicted converted-character string candidates 508 are arranged in descending order of probability. The handwriting-recognition character string candidate 506 “ [symbol] ” (Japanese hiragana character, pronounced as “gi”) is a candidate as the result of handwriting recognition. In this example, the character recognition unit 23 has correctly recognized “ [symbol] ” (Japanese hiragana character, pronounced as “gi”).

The handwriting-recognition character string candidate 506 “ [symbol] ” (Japanese hiragana character, pronounced as “gi”) is converted into a kanji character (for example, “ [symbol] ” pronounced as “gi” and having a meaning “technique”). As the converted character string candidates 507, character strings (for example, idioms including the kanji “ [symbol] ” are presented. In this example, “ [symbol] ” is an abbreviation of “ [symbol] ” (Japanese kanji character, meaning “technical pre-production” and pronounced as “gijutsu-ryousan-shisaku.”) The predicted converted-character string candidates 508 are candidates predicted from the converted character string candidates 507, respectively. In this example, as the predicted converted-character string candidates 508, “ [symbol] ” (meaning “approving technical pre-production”) and “ [symbol] ” (meaning “destination of minutes”) are displayed.

The operation command candidates 510 are candidates of predefined operation commands (command such as file operation or text editing) displayed in accordance with the recognized character. In the example of FIG. 5, a line head character “>>” 511 indicates an operation command candidate. In the example in FIG. 5, a character string candidate “ [symbol] ” (pronounced as “gijiroku” and meaning “minutes”) of “ [symbol] ” (Japanese hiragana character, pronounced as “gi”) partially matches the definition data. Thus, the operation guide 500 presents, as the operation command candidates 510 including “ [symbol] ”, “ [symbol] [symbol] ” (Japanese meaning “reading minutes templates”) and “ [symbol] [symbol] ” (Japanese meaning “storing in a minute folder”).

The operation command candidate 510 is displayed when the operation command definition data including the converted character string is found, and is not displayed in the case of no-match. In this example, the operation command candidates 510 related to the converted character string “ [symbol] ” (meaning “minutes”) are displayed.

The operation guide 500 further includes an operation header 520 including buttons 501, 502, 505, and 509. The button 501 is a graphical representation for receiving an operation of switching between predictive conversion and kana conversion. The button 502 is a graphical representation for receiving page operation of the candidate display. In the example illustrated in FIG. 5, there are three pages of candidate display, and FIG. 5 illustrates the first page. The button 505 is a graphical representation for receiving closing of the operation guide 500. When the operation receiving unit 27 receives pressing by the user of the button 505, the display control unit 24 erases the display other than the handwritten data in FIG. 5. The button 509 is a graphical representation for receiving batch deletion of the display. When the operation receiving unit 27 receives pressing by the user of the button 509, the display control unit 24 deletes the operation guide 500 and the handwritten data 504 illustrated in FIG. 5, thereby enabling the user to re-input handwriting from the beginning.

Descriptions are given below of some variations of handwritten data input by a user.

A description is given of a case in which target language is not fixed.

In a service business or the like, a language used by a communication partner may be often unknown. In such a case, it may be better for the display apparatus 2 not to fix the target language for conversion.

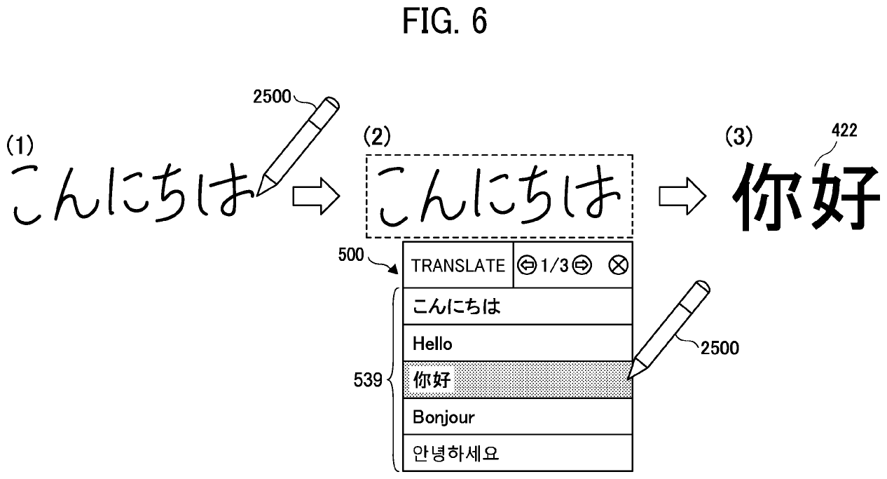

FIG. 6 is a diagram illustrating a first example of conversion of handwritten data in the case in which target language is not fixed.

(1) A user has handwritten Japanese “ [symbol] ” meaning “hello.” The drawing data generation unit 22 displays the handwritten data base on the coordinates of stroke detected by the contact position detection unit 21.

(2) When the user moves the pen 2500 away from the display, the character recognition unit 23 starts character recognition. In response to the user's handwriting, the operation guide 500 is displayed. The character recognition unit 23 generates a character string “ [symbol] ” as a direct recognition result (corresponding to the handwriting-recognition character string [symbol] candidate 506 in FIG. 5).

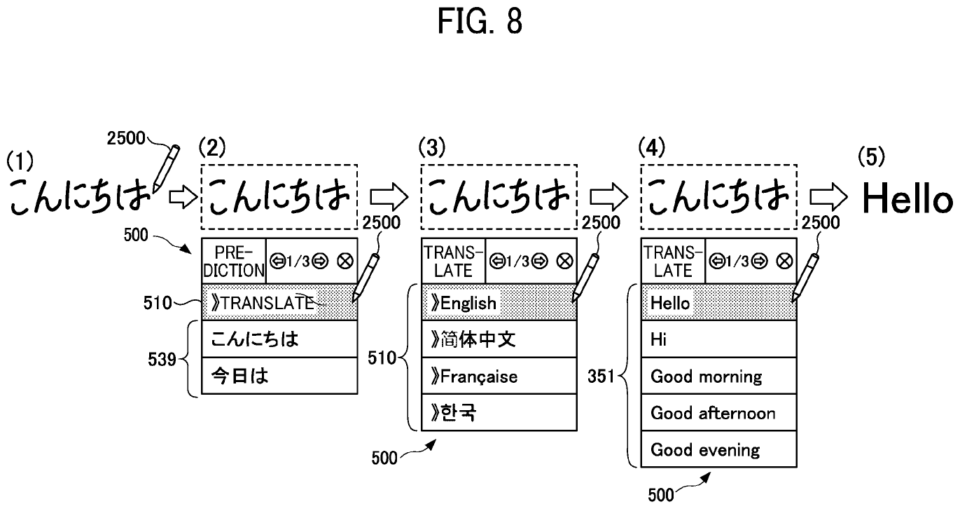

Next, the conversion unit 28 searches the predefined control data with the Japanese character string “ [symbol] ” meaning “hello” and acquires Textmeaning “hello.” The conversion unit 28 refers to the synonym dictionary 31 and identifies character strings meaning “hello” in other languages. Although Japanese “ [symbol] ” is handwritten in FIG. 6, the language of handwriting input is not limited thereto. For example, the display apparatus 2 recognizes handwritten English “hello” and displays “hello,” Japanese “ [symbol] ,” Chinese “ [symbol] ”, and French “Bonjour” in the list of synonyms. This applies to examples illustrated in FIGS. 8, 11, 13, 15, 21, 23, and the like described later.

As described above, the display control unit 24 displays the operation guide 500 in accordance with the user operations (1) and (2), and simultaneously displays a plurality of synonymous character string candidates 539 in different languages, including the input language. Note that the manner of displaying the plurality of synonymous character string candidates 539 is not limited to simultaneous displaying.

(3) When the user selects, for example, the Chinese synonym with the pen 2500, the display control unit 24 displays a character string (Chinese character string 422) in the language selected by the user.

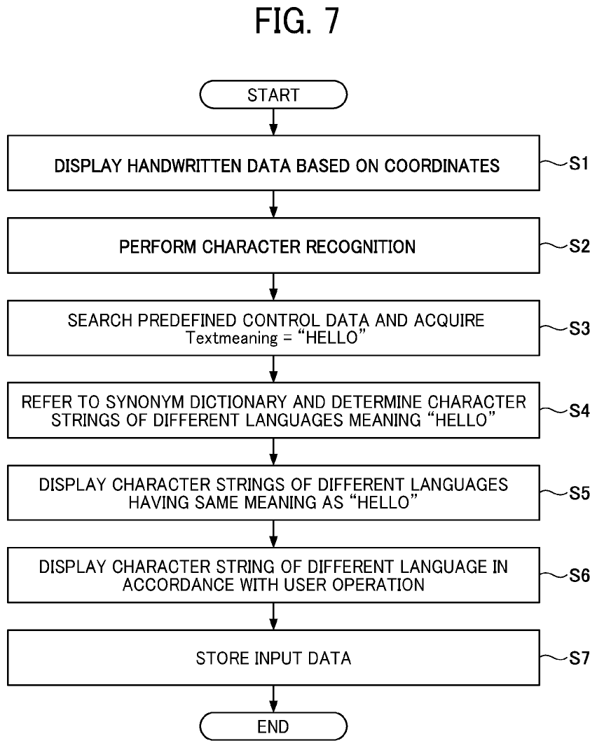

FIG. 7 is a flowchart illustrating the conversion process in FIG. 6.

The drawing data generation unit 22 displays handwritten data “ [symbol] ” (Japanese meaning “hello”) based on the coordinates of stroke detected by the contact position detection unit 21 (S1).

When the user moves the pen 2500 away from the display and suspends the handwriting, the character recognition unit 23 starts character recognition (handwriting recognition). The character recognition unit 23 converts the handwritten data into a Japanese character string “ [symbol] ” meaning “hello” as recognition result (S2).

Next, the conversion unit 28 searches the predefined control data with the character string “ [symbol] [symbol] ” and acquires Textmeaning “hello” (S3). In addition, the conversion unit 28 determines the language used by the user based on default settings or stroke data. For example, machine learning may be used to determine the language used by the user based on the stroke data. A developer prepares training data in which stroke data and a use language are paired, and generates a learned model by an algorithm such as a neural network or a support vector machine. In this example, the language used by the user is determines as Japanese.

The conversion unit 28 refers to the synonym dictionary 31 and identifies character strings meaning “hello” in languages other than Japanese (S4).

The display control unit 24 displays the operation guide 500 including the recognized Japanese character string “ [symbol] ” and a plurality of character string candidates 539 in other languages, synonymous with the recognized Japanese (S5).

In response to receiving the selection of one of the character string candidates 539 from the user, the display control unit 24 displays, on the screen, a character string in the language selected by the user (S6). The conversion unit 28 determines the language of the character string selected by the user. For example, the language of the selected character string is Chinese.

The data recording unit 25 stores the attributes of the character string displayed in the input data storage area 33 (S7). The attributes characteristic in this embodiment are text, meaning, and language. The other attributes are set to default values, for example.

As described above, when the user inputs handwritten data, the display apparatus 2 displays, in addition to a character string in the input language, character strings in other languages having the same meaning.

A description is given below of a second example of conversion of handwritten data in the case in which target language is not fixed. The operation guide 500 may first display the target language instead of directly displaying the conversion candidate character strings as illustrated in FIG. 6. For example, English expressions synonymous with “hello” include “Hello” and “Hi.” “Good morning” and the like having a similar meaning are also candidates. When the display apparatus 2 displays a plurality of synonymous character strings in one target language, the number of candidates is large. It takes time and effort for the user to select one from the choices. In the case where the number of candidates in one language may be enormous as described above, when the display apparatus 2 employs a user interface that receives a target language first, handling multiple languages becomes easier.

FIG. 8 is a diagram illustrating a second example of conversion of handwritten data in the case in which target language is not fixed.

(1) A user has handwritten Japanese “ [symbol] ” meaning “hello.” The drawing data generation unit 22 displays the handwritten data based on the coordinates of stroke detected by the contact position detection unit 21.

(2) When the user moves the pen 2500 away from the display, the character recognition unit 23 starts character recognition. The character recognition unit 23 generates a character string “ [symbol] ” as a direct recognition result (corresponding to the handwriting-recognition character string candidate 506 in FIG. 5).

Next, since the character string “ [symbol] ” is registered in the predefined control data, the conversion unit 28 displays an operation command “translate.” The display apparatus 2 may receive user setting in advance, so that the display apparatus 2 displays the operation command “translate.” According to the operation command “translate,” the display apparatus 2 executes the processing “displaying a list of target languages” (a list of languages into which the display apparatus 2 converts a character string).

As described above, the display control unit 24 displays the operation guide 500 in accordance with the user operations (1) and (2), and displays the operation command candidate 510 “translate” and the character string candidate 539 in the recognized language.

In FIG. 8, the display control unit 24 displays character string candidates 539 as options in addition to the operation command candidate 510 “translate,” to enable the user to select a character string when the user wants to input characters of the recognized language instead of translation.

(3) When the user selects the operation command candidate 510 “translate” with the pen 2500, the display control unit 24 displays a list of target languages (target language options) in the processing “displaying a list of target languages.” The list of target languages may be a list of languages set in the synonym dictionary 31. The language options also serve as operation commands 510.

(4) When the user selects the language option “English” with the pen 2500, the display control unit 24 displays an English character string meaning “hello” and synonyms 351 thereof on the operation guide 500. That is, the conversion unit 28 acquires Textmeaning=“hello” by searching the predefined control data with a search key of Japanese character string “ [symbol] ” meaning “hello.” Next, the conversion unit 28 refers to the synonym dictionary 31 and identifies an English character string meaning “hello.” Further, the conversion unit 28 refers to a general-purpose synonym dictionary and acquires, for example, “hi,” “good morning,” “good afternoon,” and “good evening” synonymous with “hello.”

(5) When the user selects “hello” with the pen 2500, the display control unit 24 displays “hello” selected by the user.

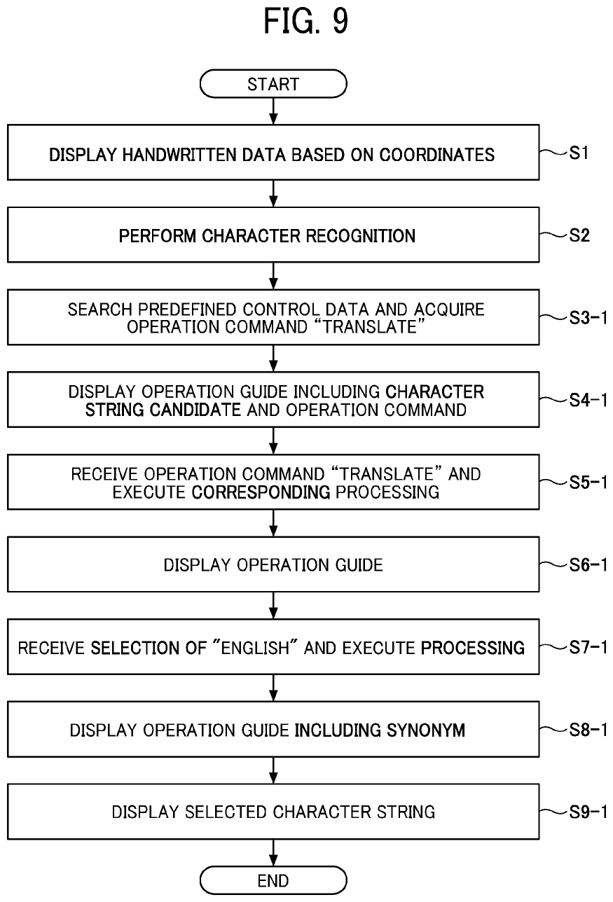

FIG. 9 is a flowchart illustrating an example of the conversion (translation) example of FIG. 8.

The drawing data generation unit 22 displays handwritten data “ [symbol] ” (Japanese meaning “hello”) based on the coordinates of stroke detected by the contact position detection unit 21 (S1).

The character recognition unit 23 starts character recognition. The character recognition unit 23 generates a character string “ [symbol] ” as a direct recognition result (S2).

Next, when the conversion unit 28 searches the predefined control data with “ [symbol] ” the conversion unit 28 determines to display the operation command “translate” based on the determination that “ [symbol] ” has been registered in the predefined control data or based on the user setting (S3-1). The conversion unit 28 determines based on the stroke data of “ [symbol] [symbol] ” that the character string is Japanese.

The display control unit 24 displays the operation guide 500 including the character string candidates in the determined language and the operation command “translate” (S4-1).

The operation receiving unit 27 receives the operation command “translate” from the operation guide 500, and the conversion unit 28 executes the processing instructed by the operation command (55-1). The processing instructed by the operation command is “displaying a list of target languages.”

As a result of “displaying a list of target languages,” the display control unit 24 displays a list of languages registered in the synonym dictionary 31 on the operation guide 500 as target languages (S6-1).

When the operation receiving unit 27 receives a language option “English” from the operation guide 500, the conversion unit 28 executes processing corresponding to this operation command (S7-1). The processing corresponding to this operation command is “displaying English synonym.” The conversion unit 28 searches the predefined control data with the Japanese character string “ [symbol] ” meaning “hello” and acquires Textmeaning “hello.” The conversion unit 28 refers to the synonym dictionary 31 and identifies an English character string meaning “hello.” The conversion unit 28 refers to the general-purpose synonym dictionary and identifies the synonym of “hello.” The display control unit 24 displays the operation guide 500 including “hello” and synonyms thereof (S8-1).

In response to receiving the selection of the character string candidate 539 from the user, the display control unit 24 displays, on the screen, the character string selected by the user (S9-1). The data recording unit 25 stores the attribute of the character string displayed in the input data storage area 33.

In this manner, the display apparatus 2 first receives the target language and displays the character string candidates in that language.

As described above, the display apparatus 2 according to the present embodiment displays a character strings in different languages or displays language options. Thus, in a workplace or a site where different language speakers are mixed, the display apparatus 2 facilitates communication in a situation where a person does not know the language of the communication partner well or a person does not know which language the communication partner understands.

### Embodiment 2

Fixing the target language is desirable when the user predicts or knows which language the partner of information communication uses, such as in a meeting with a known overseas business partner. In the present embodiment, descriptions are given of several examples of the case in which target language is fixed.

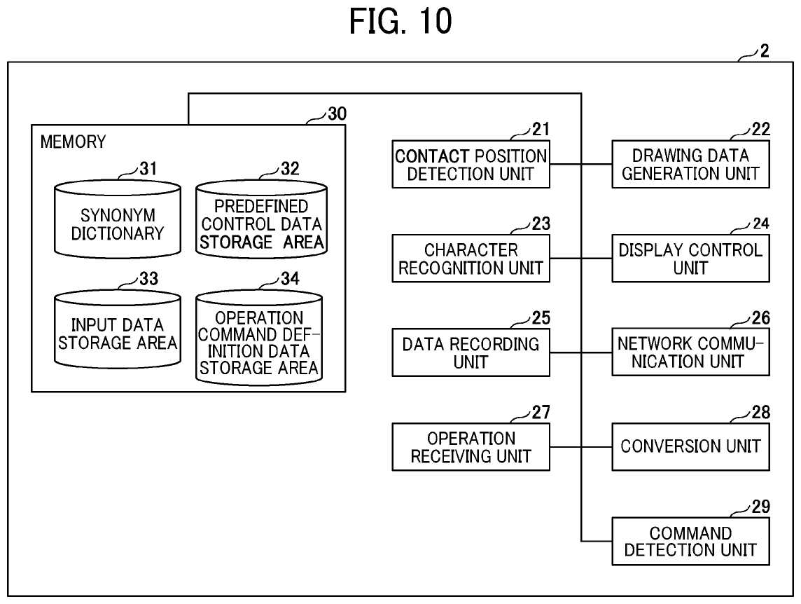

FIG. 10 is a block diagram illustrating an example of the functional configuration of the display apparatus 2 according to the present embodiment. Elements in FIG. 10 given reference characters that are the same as those in FIG. 4 operate similarly and attain the same effect. Accordingly, only the main elements that differ from those in FIG. 4 are described below.

The display apparatus 2 of the present embodiment includes a command detection unit 29. The command detection unit 29 refers to an operation command definition data storage area 34, and determines whether a character string input by a user includes an operation command. The command detection unit 29 causes the display control unit 24 to display the operation command corresponding to the character string.

The display apparatus 2 of the present embodiment stores the operation command definition data storage area 34 in the memory 30.

TABLE 4
Operation command definition data example

| | |
|---|---|
| 401 | Name=“Translate to English” String=“ [symbol] ” |
| | String=“English” String=“ [symbol] ” |
| | String= [symbol] ” String= [symbol] ” String= [symbol] ” |
| | String=“America” |
| | String=“British” |
| | Command=“Changelanguageto English” |
| 402 | Name=“ Translate to Korean” String=“ [symbol] ” |
| | String=“ [symbol] ” String=“Korean” |
| | String=“ [symbol] ” String=“ [symbol] ” String=“ [symbol] ” |
| | String=“ [symbol] ” |
| | Command=“Changelanguageto Korean” |

Table 4 is an example of operation command definition data for a user to explicitly set a target language. The contents of attributes are presented below.

“Name” is a display name of an operation command.

“String” is a character string for the user to call this operation command.

“Command” represents the processing executed by the operation command.

For example, in operation command definition data 401, character strings related to English are set to strings. Examples of strings include “ [symbol] ” (Japanese meaning English), “ [symbol] ” (Japanese hiragana characters meaning English), “ [symbol] ” (Japanese katakana characters meaning United States, “ [symbol] ” (Japanese katakana characters meaning British), and “ [symbol] [symbol] ” (Japanese katakana characters meaning Australia). In operation command definition data 402, character strings related to Korean are set to strings. Examples of strings include “ [symbol] ” (Japanese meaning Korean), “ [symbol] ” (Japanese katakana characters meaning Hangul), “ [symbol] ” (Japanese hiragana characters meaning Hangul, “ [symbol] ” (Japanese meaning Korea), “ [symbol] ” (Japanese hiragana characters meaning Korea), and “ [symbol] ” (Japanese katakana characters meaning Korea). When the command detection unit 29 detects such a character string, the display control unit 24 displays the name attribute of the corresponding operation command as the operation command candidate 510.

A description is given below of a first example of conversion of handwritten data in the case in which target language is fixed.

The display apparatus 2 fixes the target language to the language of a character string selected by the user. Specifically, the conversion unit 28 determines the language of the character string selected last time referring to the input data storage area 33, and refers to only the character strings in the determined language in the synonym dictionary. With this configuration, the conversion unit 28 converts the handwritten data into the same language in each conversion.

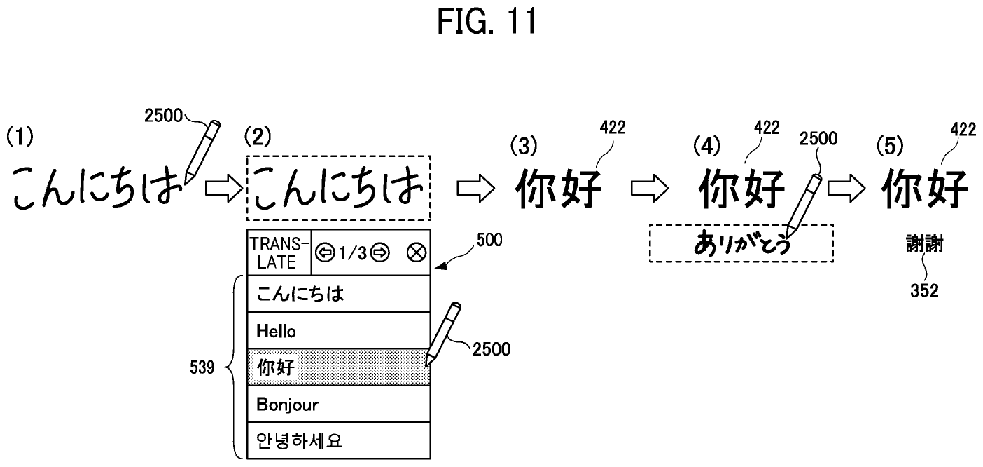

FIG. 11 is a diagram illustrating a first example of conversion of handwritten data in the case in which target language is fixed. The operations (1) to (3) may be the same as those in the first example of the case in which target language is not fixed, illustrated in FIG. 6. In the operation (3), the conversion unit 28 determines that the synonymous character string 350 selected by the user is Chinese, referring to the input data storage area 33, and fixes the target language to Chinese.

(4) The user has handwritten Japanese “ [symbol] ” meaning “thank you.” The drawing data generation unit 22 displays the handwritten data based on the coordinates of stroke detected by the contact position detection unit 21.

(5) When the user removes the pen 2500 from the display, the character recognition unit 23 starts character recognition. The character recognition unit 23 generates, as a direct recognition result, Japanese “ [symbol] ” meaning “thanks.”

Next, the conversion unit 28 searches the predefined control data with the Japanese character string “ [symbol] ” meaning “thanks” and acquires Textmeaning “thanks.” The conversion [symbol] unit 28 refers to the synonym dictionary 31 and identifies a Chinese character string meaning “thanks.”

The display control unit 24 displays a Chinese character string 352 “ [symbol] ” meaning “thanks,” without displaying the operation guide 500.

Thus, the display apparatus 2 obviates the user's selecting the target language at each of handwriting input. The display apparatus 2 displays the character string in the target language without being selected. The display control unit 24 may display the operation guide 500 even when the target language is fixed. In this case, words including the Chinese “ [symbol] ” and predictive conversion results are displayed similar to in the case of Japanese handwriting.

Further, for example, operation commands such as “reset” and “ [symbol] ” (Japanese katakana character string meaning “reset”) are prepared so that the user instructs the display apparatus 2 to reset the fixed target language setting.

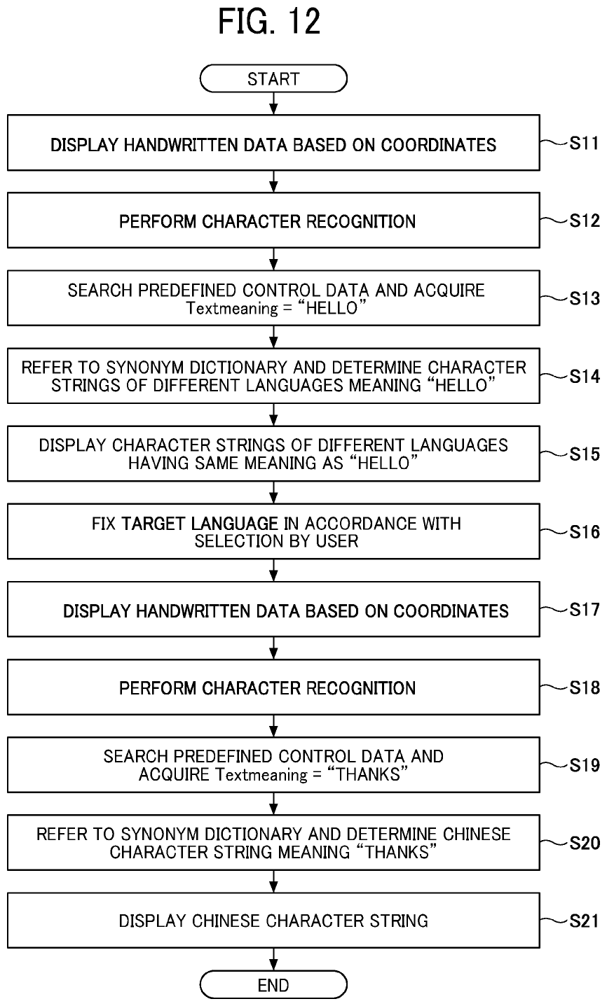

FIG. 12 is a flowchart illustrating an example of process of conversion illustrated in FIG. 11. The description referring to FIG. 12 (and FIG. 11) is focused on differences from FIG. 7. Steps S11 to S15 are similar to steps S1 to S5 in FIG. 7.

Next, the conversion unit 28 determines that the language of the character string selected by the user is Chinese, and fixes the target language to Chinese (S16).

The drawing data generation unit 22 displays the handwritten data “ [symbol] ” (Japanese meaning “thanks”) based on the coordinates of stroke detected by the contact position detection unit 21 (S17).

When the user releases the pen 2500 from the display (screen), the character recognition unit 23 starts character recognition. The character recognition unit 23 generates, as a direct recognition result, Japanese “ [symbol] ” meaning “thanks” (S18).

Next, the conversion unit 28 searches the predefined control data with the Japanese character string “ [symbol] ” meaning “thanks” and acquires Textmeaning “thanks” (S19).

Next, the conversion unit 28 refers to the synonym dictionary 31 and identifies a Chinese character string (target language is fixed) meaning “thanks” (S20).

The display control unit 24 displays, on the screen, a Chinese character string meaning “thanks” without displaying the operation guide 500 (S21).

The data recording unit 25 stores the input data of the Chinese character string meaning “thanks” in the input data storage area 33. The input data has attributes Text=“ [symbol] ” meaning=“thanks,” and Language=“Chinese.”

As described above, since the target language is fixed, users can efficiently communicate with each other.

A description is given below of a second example of conversion of handwritten data in the case in which target language is fixed.

In this example, the display apparatus 2 may receive from the user whether or not to fix the target language. For example, after the display apparatus 2 displays the Chinese character string converted from the Japanese handwritten data “ [symbol] ” meaning “hello,” the display apparatus 2 displays the Chinese character string converted from the second handwritten Japanese “ [symbol] ” meaning “thanks.” The display apparatus 2 detects that the handwritten data has been converte tot e same language twice in succession, and displays an inquiry of whether to set the particular language as the target language. An example of the inquiry is a dialog including a message such as: “Do you want to fix the translation target language (output language) to Chinese?” The operation receiving unit 27 receives instruction to fix the target language by the user's selection of a Yes button or a No button.

Note that the display apparatus 2 may display a dialog when the user has selected a character string of another language once, which is when the user has selected the Chinese character string corresponding to the handwritten Japanese “ [symbol] ” meaning “hello” in the example of FIG. 11. In this way, the display apparatus 2 may display a dialog when the user consecutively selects a character string of another language a certain number of times (including once) or more.

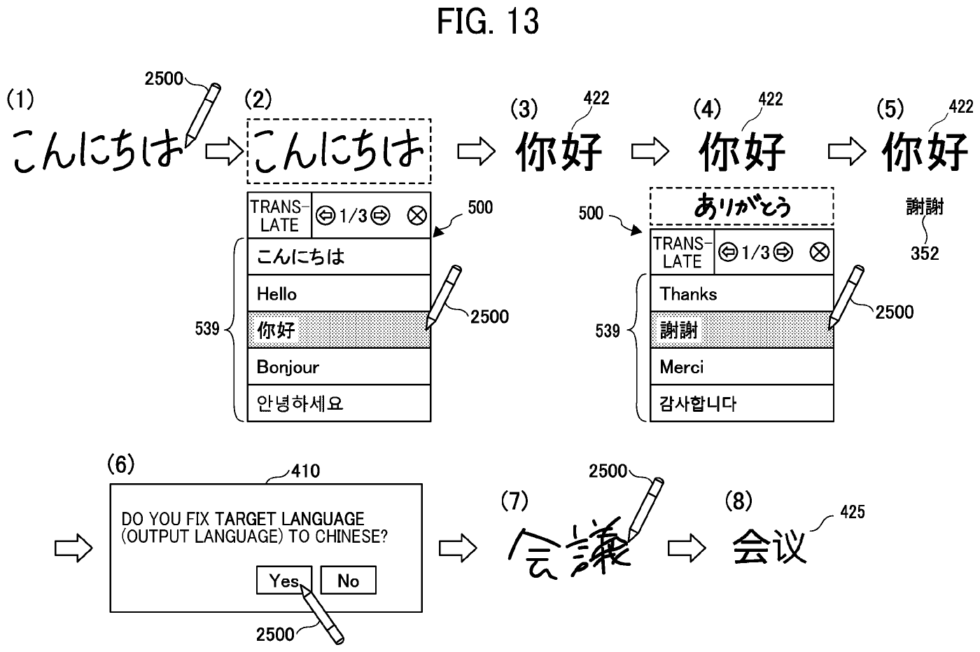

FIG. 13 is a diagram illustrating the second example of conversion of handwritten data in the case in which target language is fixed. The operations (1) to (3) may be the same as those in the first example of the case in which target language is not fixed, illustrated in FIG. 6.

(4) The user has handwritten Japanese “ [symbol] ” meaning “thanks.” The drawing data generation unit 22 displays the handwritten data based on the coordinates of stroke detected by the contact position detection unit 21. When the user removes the pen 2500 from the display, the character recognition unit 23 starts character recognition. The character recognition unit 23 generates a character string “ [symbol] ” as a direct recognition result (corresponding to the handwriting-recognition character string candidate 506 in FIG. 5).

Next, the conversion unit 28 searches the predefined control data with the Japanese character string “ [symbol] ” meaning “thanks” and acquires Textmeaning “thanks.” The conversion unit 28 refers to the synonym dictionary 31 and identifies a character string of another language meaning “thanks.”

The display control unit 24 displays the operation guide 500 including a list of character strings in different language, synonymous with the Japanese “ [symbol] ” meaning “thanks.”

(5) In response to receiving a user's selection of the character string candidate 539 in another language in the operation guide 500, the display control unit 24 displays, on the screen, a character string 352 corresponding to the selected character string candidate 539.

(6) Since Chinese has been selected twice in succession in (2) and (4), the display control unit 24 displays a dialog 410 asking whether or not to fix the target language to Chinese. In this example, the user selects the Yes button. The conversion unit 28 fixes the target language to Chinese.

(7) The user has handwritten Japanese “ [symbol] ” meaning “meeting.” The drawing data generation unit 22 displays the handwritten data based on the coordinates of stroke detected by the contact position detection unit 21.

(8) Since the target language is fixed to Chinese, the conversion unit 28 converts “ [symbol] ” into Chinese and displays a Chinese character string 425 meaning “meeting.” The display apparatus 2 may display the operation guide 500 including the Chinese character string candidate 539.

Thus, the display apparatus 2 fixes the target language under the consent of the user.

In the second example of the case in which target language is fixed, the display apparatus 2 allows the user to reset the fixed target language similarly.

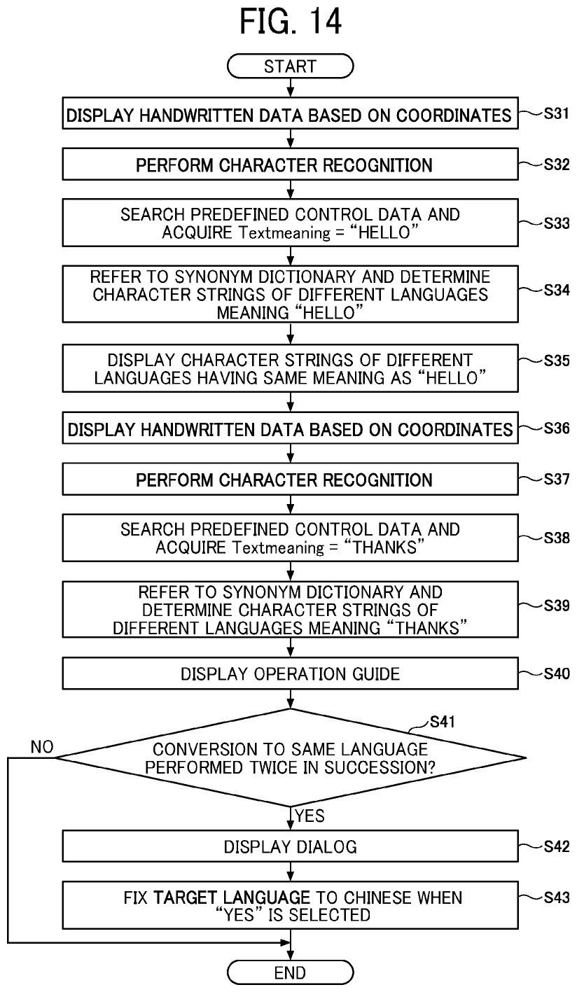

FIG. 14 is a flowchart illustrating an example of process of conversion illustrated in FIG. 13. The description referring to FIG. 14 (and FIG. 13) is focused on differences from FIG. 12. Steps S31 to S35 are similar to steps S11 to S15 in FIG. 12.

The drawing data generation unit 22 displays handwritten data “ [symbol] ” (Japanese meaning “thanks”) based on the coordinates of stroke detected by the contact position detection unit 21 (S36).

When the user moves the pen 2500 away from the display and suspends the handwriting, the character recognition unit 23 starts character recognition (handwriting recognition). The character recognition unit 23 generates “ [symbol] ” as a direct recognition result (S37).

Next, the conversion unit 28 searches the predefined control data with the Japanese character string “ [symbol] ” meaning “thanks” and acquires Textmeaning “thanks” (S38).

The conversion unit 28 refers to the synonym dictionary 31 and identifies character strings meaning “thanks” in languages other than Japanese (S39).

The display control unit 24 displays the operation guide 500 including the recognition result “ [symbol] ” (Japanese meaning “thanks”) and a list of character strings in a plurality of different languages, synonymous with the Japanese “ [symbol] ” (S40).

In response to receiving selection of the character string candidate 539 from the user, the conversion unit 28 determines whether or not the character string candidate has been converted into the same language twice in succession (S41).

When the determination of step S42 is Yes, the display control unit 24 displays the dialog 410 (S42).

When the Yes button is pressed in the dialog 410, the conversion unit 28 fixes the target language to Chinese (S43).

Note that the display apparatus 2 may display the dialog 410 based on conversion to the same target language once or more, not limited to two consecutive times, and the target language may be fixed under the consent of the user.

A description is given below of a third example of conversion of handwritten data in the case in which target language is fixed.

The display apparatus 2 may enable the user to select the target language by handwriting a character string of the target language. The operation command definition data enables such processing.

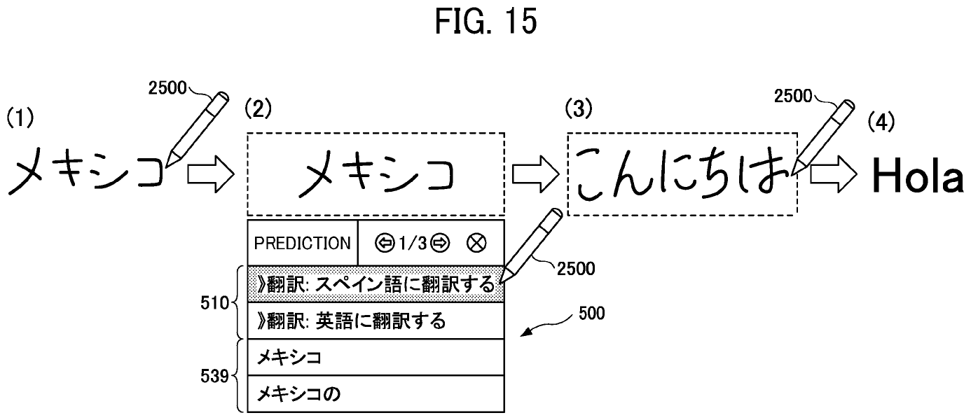

FIG. 15 is a diagram illustrating a third example of conversion of handwritten data in the case in which target language is fixed.

(1) The user has handwritten Japanese “ [symbol] ” meaning “Mexico.” This case is on the assumption that the communication partner is from Mexico. The drawing data generation unit 22 displays the handwritten data based on the coordinates of stroke detected by the contact position detection unit 21.

(2) When the user moves the pen 2500 away from the display, the character recognition unit 23 starts character recognition. The character recognition unit 23 generates “ [symbol] ” meaning “Mexico” as a direct recognition result (corresponding to the handwriting-recognition character string candidate 506 in FIG. 5).

Next, the command detection unit 29 searches the predefined control data with Japanese character string “ [symbol] ” and acquires command names “ [symbol] ” (meaning “translate to Spanish”) and “ [symbol] ” (meaning “translate to English”).

The display control unit 24 displays the operation guide 500 including Japanese character string candidates 539 and operation command candidates 510. In this example, the user has selected “ [symbol] ” (meaning “translate to Spanish”). The conversion unit 28 executes the operation command and sets the target language to Spanish. Input language is not limited to Japanese. When the user handwrites “Mexico” in operation (1), the character recognition unit 23 generates a direct recognition result “Mexico”. The display control unit 24 displays, on the operation guide 500, the command candidates 510 “translate to Spanish” and “translate to English” based on the retrieval from the predefined control data by the command detection unit 29 with “Mexico.”

(3) A user has handwritten Japanese “ [symbol] ” meaning “hello.” The drawing data generation unit 22 displays the handwritten data based on the coordinates of stroke detected by the contact position detection unit 21.

(4) When the user removes the pen 2500 from the display, the character recognition unit 23 starts character recognition. The character recognition unit 23 generates a character string “ [symbol] [symbol] ” as a direct recognition result. Since the target language is fixed to Spanish, the conversion unit 28 converts “ [symbol] ” into Spanish. The conversion method may be the same as that described above.

The display apparatus 2 may display the operation guide 500 in the operation (4) above. In this case, the operation guide 500 displays “Hola” meaning “hello” in Spanish and Spanish character string candidates 539.

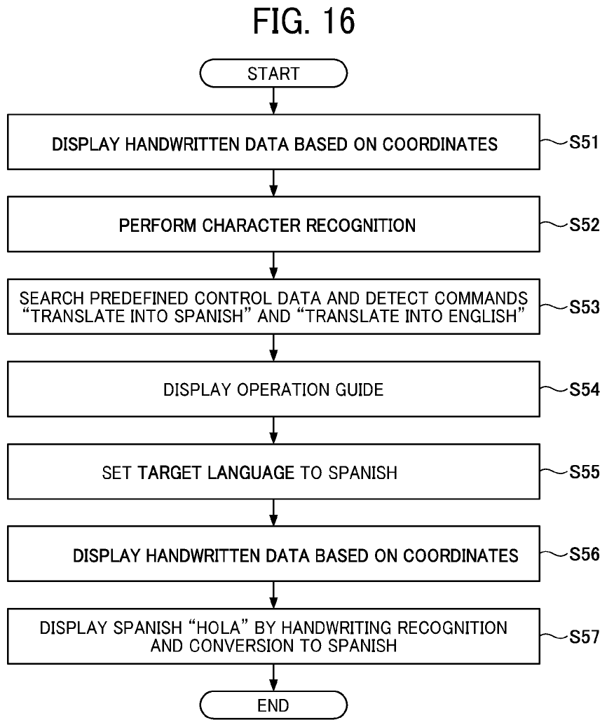

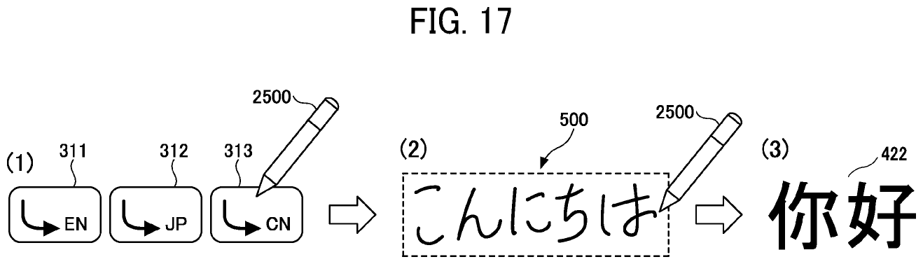

FIG. 16 is a flowchart illustrating an example of process of conversion illustrated FIG. 15.

The drawing data generation unit 22 displays the handwritten data “ [symbol] ” (Japanese meaning “Mexico”) based on the coordinates of stroke detected by the contact position detection unit 21 (S51).

When the user removes the pen 2500 from the display, the character recognition unit 23 starts character recognition. The character recognition unit 23 generates “Mexico” as a direct recognition result (S52).

Next, the command detection unit 29 searches the operation command definition data with Japanese character string “ [symbol] ” and acquires command names “translate to Spanish” and “translate to English” (S53).

The display control unit 24 displays the operation guide 500 including the Japanese character string candidates 539 and operation command candidates 510 (S54).

When the user selects “translate to Spanish,” the conversion unit 28 sets the target language to Spanish by executing the operation command (S55).

The user handwrites Japanese “ [symbol] ” meaning “hello.” The drawing data generation unit 22 displays handwritten data “ [symbol] ” (Japanese meaning “hello”) based on the coordinates detected by the contact position detection unit 21 (S56).

When the user removes the pen 2500 from the display, the character recognition unit 23 starts character recognition. The character recognition unit 23 generates a character string “ [symbol] [symbol] ” as a direct recognition result. The conversion unit 28 searches the predefined control data with the Japanese character string “ [symbol] ” meaning “hello” and acquires Textmeaning “hello.” Since the target language is set to Spanish, the conversion unit 28 refers to the synonym dictionary 31 and identifies the Spanish character string “Hola” meaning “hello.” The display control unit 24 displays, on the screen, the Spanish character string “S57” without displaying the operation guide 500 (S57).

Thus, the display apparatus 2 enables the user to select the target language by handwriting a character string of the target language. This configuration enables the user to set an appropriate target language even when the user knows only the country of origin of the communication partner.

A description is given below of a fourth example of conversion of handwritten data in the case in which target language is fixed.

For setting the target language, the display apparatus 2 may provide icon buttons (representation of language option) for the user to select the target language option or may recognize the target language input by voice. The icon button is a display component that is displayed in addition to an illustration or a character and receives selection. Such a display component is also referred to as a soft key or a graphical representation.

FIG. 17 illustrates an example of icon buttons for setting a target language.

In FIG. 17, three icon buttons 311 to 313 are displayed. The icon button 311 is for the user to set the target language to English. The icon button 312 is for the user to set the target language to Japanese. The icon button 313 is for the user to set the target language to Chinese.
(1) In response to the user's pressing the icon button 313 for setting the target language to Chinese, the conversion unit 28 sets the target language to Chinese.
(2) When the user handwrites, for example, “ [symbol] ” (3) the conversion unit 28 displays a Chinese character string converted the handwriting. The display apparatus 2 may display the operation guide 500. In this case, the operation guide 500 displays the Chinese character string 422 meaning “hello.”

Thus, the display apparatus 2 enables the user to select the target language with the icon button.

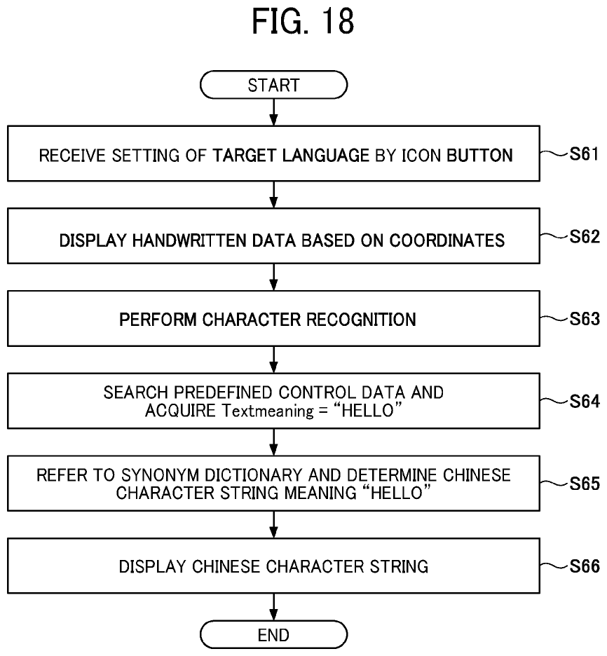

FIG. 18 is a flowchart illustrating an example of process of conversion illustrated FIG. 17. The process illustrated in FIG. 18 is on the assumption that the icon buttons have already been displayed. The icon button may be constantly displayed or may be displayed in response to an operation of the user.

The operation receiving unit 27 receives setting of a target language with the icon button (S61). In this example, the operation receiving unit 27 has received setting of Chinese.

The drawing data generation unit 22 displays handwritten data “ [symbol] ” (Japanese meaning “hello”) based on the coordinates of stroke detected by the contact position detection unit 21 (S62).

When the user removes the pen 2500 from the display, the character recognition unit 23 starts character recognition. The character recognition unit 23 generates the character string “ [symbol] [symbol] ” as a direct recognition result (S63).

Next, the conversion unit 28 searches the predefined control data with the Japanese character string “ [symbol] ” meaning “hello” and acquires Textmeaning “hello” (S64).

Next, since the target language is Chinese, the conversion unit 28 refers to the synonym dictionary 31 and identifies a Chinese character string meaning “hello” (S65).

The display control unit 24 displays the Chinese character string converted from “ [symbol] [symbol] ” (S66). The display control unit 24 may or may not display the operation guide 500.

As described above, the display apparatus 2 according to the present embodiment fixes the target language. This configuration makes the communication easier when the user presumes or determines the language used by the communication partner.

### Embodiment 3

In Embodiment 3, a description is given of a case commonly applied to the case in which target language is not fixed (Embodiment 1) and the case in which target language is fixed (Embodiment 2). This case is referred to as “commonly applicable case” for convenience.

The description below is on the assumption that the functional configuration illustrated in the block diagram of FIG. 10 in Embodiment 2 adapt to the present embodiment.

A description is given of a first example of the commonly applicable case.

The display apparatus 2 may display both the source language and the target language so that the user who performs handwriting and the communication partner who receives information can understand the meaning of the information at a glance.

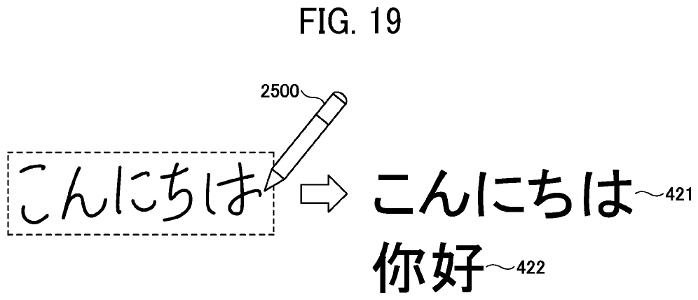

FIG. 19 illustrates a display example of both the source language and the target language. It is assumed that the target language is fixed to Chinese. In FIG. 19, with respect to “ [symbol] [symbol] ” (Japanese meaning “hello”) handwritten by the user, a Japanese character string 421 obtained by handwriting recognition from the handwritten data and a Chinese character string 422 converted therefrom are displayed. Specifically, the display control unit 24 display both the source language and the target language.

Note that when the display apparatus 2 displays a plurality of character strings, the operation guide 500 is not displayed, but may be displayed. In the case of displaying the operation guide 500, the display control unit 24 separately displays the operation guides 500 of Japanese and China, or one operation guide 500 receives selection of two character strings.

The process performed by the display apparatus 2 may be the same as that in FIGS. 16 and 18 except that a plurality of target languages is used.

Further, the number of target languages is not limited to one, and may be two or more. In this case, a plurality of languages is defined as target languages in the operation command definition data. This allows for “one language” to “multilingual” conversion as well as “one language” to “one language” conversion.

TABLE 5
Operation command definition data example
Name= ”Translate to English and Chinese” String “English and Chinese”
String=“ [symbol] ” String “ [symbol] ” String “ [symbol] ”
Command “Changelanguageto English and Chinese”

Table 5 presents an example of operation command definition data to enable “one language” to “multilingual” conversion. The recognized character strings are “English and Chinese,” “ [symbol] ” (Japanese meaning English and Chinese) and “ [symbol] ” (Japanese meaning USA and China). When these are handwritten, “translate to English and Chinese” is displayed in the operation command candidate 510, as a combination of target languages associated with the detected operation command. When the user selects “translate to English and Chinese,” the target language is set to two languages: English and Chinese.

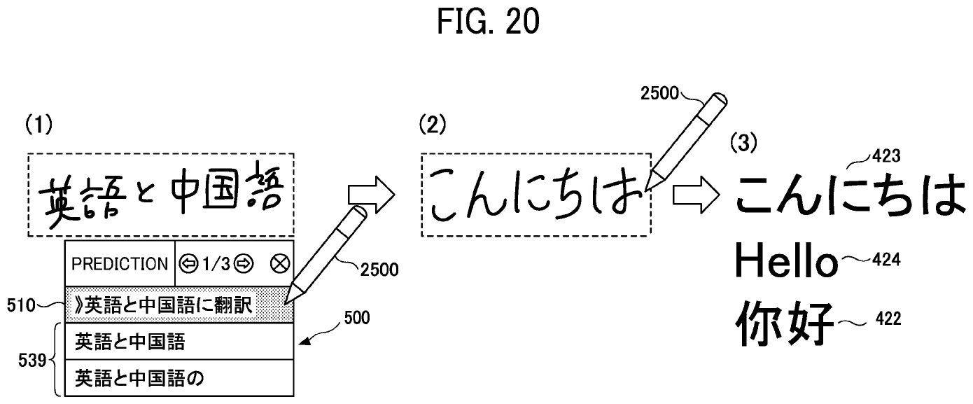

FIG. 20 is a diagram illustrating an example of conversion into English and Chinese as examples of two target languages.

(1) The user has handwritten Japanese “ [symbol] ” meaning “English and Chinese.” The drawing data generation unit 22 displays the handwritten data based on the coordinates of stroke detected by the contact position detection unit 21.

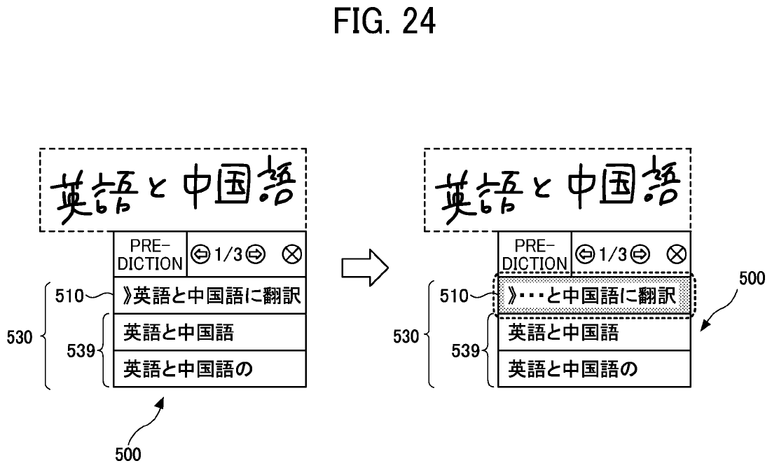

When the user removes the pen 2500 from the display, the character recognition unit 23 starts character recognition. The character recognition unit 23 generates “ [symbol] ” as a direct recognition result. The command detection unit 29 searches the operation command definition data with “ [symbol] ” and detects an operation command “translate to English and Chinese.” The display control unit 24 displays the operation guide 500 including the Japanese character string candidates 539 and operation command candidates 510 (operation command involving two target languages). When the handwriting is “English and Chinese,” the character recognition unit 23 generates “English and Chinese” as a direct recognition result, and the operation guide 500 displays the operation command candidate 510 “translate to English and Chinese.” This applies to the example illustrated in FIG. 24. When the user selects the operation command “ [symbol] [symbol] ” (Japanese meaning “translate to English and Chinese”), the conversion unit 28 executes “translate to English and Chinese” to set the target language to English and Chinese.

(2) The user has handwritten Japanese “ [symbol] ” meaning “hello.” The drawing data generation unit 22 displays the handwritten data based on the coordinates of stroke detected by the contact position detection unit 21.

(3) When the user releases the pen 2500 from the display, the character recognition unit 23 starts character recognition. The character recognition unit 23 generates a character string “ [symbol] [symbol] ” as a direct recognition result. The conversion unit 28 converts “ [symbol] ” into English and Chinese which are the target languages. The display control unit 24 displays a Japanese character string 423, an English character string 424, and the Chinese character string 422.

The process performed by the display apparatus 2 may be the same as that in FIG. 16 except that a plurality of target languages is used.

A description is given below of a second example of the commonly applicable case. In some cases, the number of conversion candidates in one language is large. In such a case, the display apparatus 2 may display the operation guide 500 including a plurality of different language conversion candidates in which one language includes a plurality of candidates.

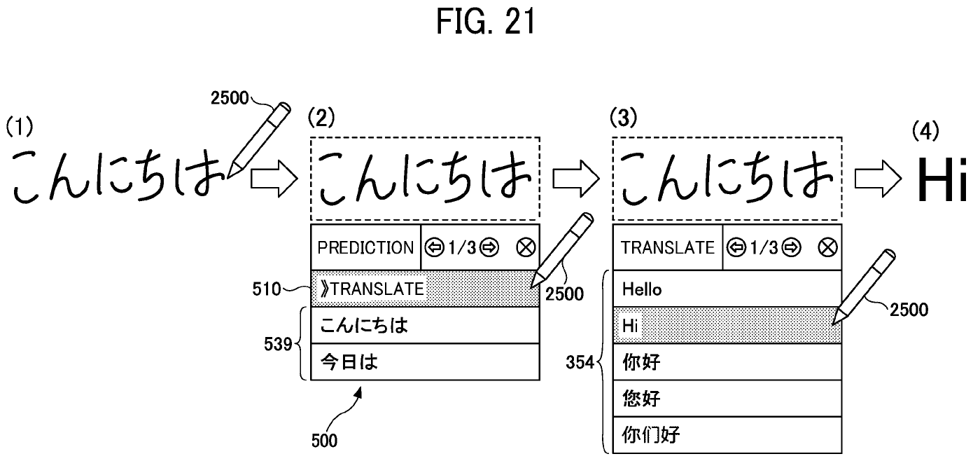

FIG. 21 is a diagram illustrating an example of conversion into English and Chinese.

(1) A user has handwritten Japanese “ [symbol] ” meaning “hello.” The drawing data generation unit 22 displays the handwritten data based on the coordinates of stroke detected by the contact position detection unit 21.

(2) When the user moves the pen 2500 away from the display, the character recognition unit 23 starts character recognition. The character recognition unit 23 generates a character string “ [symbol] ” as a direct recognition result (corresponding to the handwriting-recognition character string candidate 506 in FIG. 5).

Next, since the character string “ [symbol] ” is registered in the predefined control data, the conversion unit 28 displays an operation command “translate.” Alternatively, the conversion unit 28 displays the operation command according to the user setting. According to the operation command “translate,” the display apparatus 2 executes the processing “displaying a list of target languages.”

As described above, the display control unit 24 displays the operation guide 500 in accordance with the user operations (1) and (2), and displays the operation command candidate 510 “translate” and the character string candidate 539 in the recognized language. The content of the operation command is different from that of Embodiment 1 illustrated in FIG. 8.

In FIG. 21, the display apparatus 2 displays the character string candidates 539 as options in addition to the operation command candidate 510, to enable the user to select a character string when the user wants to input characters recognized language instead of translation.

(3) When the user selects the operation command candidate 510 “translate” with the pen 2500, the display control unit 24 displays a list 354 of a plurality of character strings in different languages on the operation guide 500, based on the processing “multilingual conversion.” The conversion unit 28 searches the predefined control data with the Japanese character string “ [symbol] ” meaning “hello” and acquires Textmeaning “hello.” The conversion unit 28 refers to the synonym dictionary 31 and identifies character strings meaning “hello” in other languages. The conversion unit 28 refers to a general-purpose synonym dictionary and identifies one or more English synonyms (e.g., Hi) meaning “hello” and Chinese synonyms (e.g., [symbol] meaning “hello.”

(4) When the user selects “Hi” with the pen 2500 from the list 354, the display control unit 24 displays “Hi” on the screen.

As described above, the display apparatus 2 displays synonyms in a plurality of languages so as to enhance the possibility of displaying a character string that the user intended to select. Unlike FIG. 8, it is not necessary for the display apparatus 2 to display the target language.

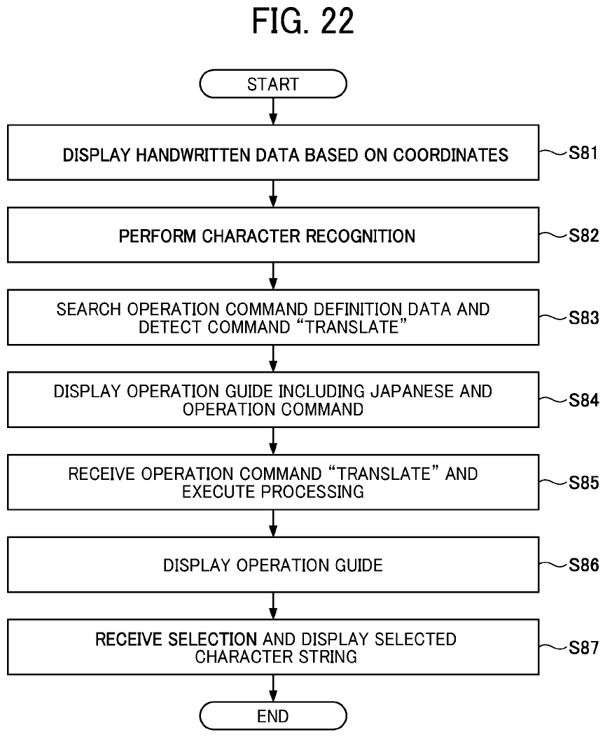

FIG. 22 is a flowchart illustrating an example of process of conversion illustrated FIG. 21. In the description referring to FIG. 22, for simplicity, only the main differences from FIG. 9 are described. The steps S81 to S84 are same as S1 to S4-1 in FIG. 9.

The operation receiving unit 27 receives the operation command “translate” from the operation guide 500, and the conversion unit 28 executes the processing instructed by the operation command (55-1). The processing instructed by the operation command is “multilingual conversion.”

As a result of “multilingual conversion” processing, the conversion unit 28 identifies character strings in other languages meaning “hello (Textmeaning=“hello”) referring to the synonym dictionary 31. The conversion unit 28 refers to a general-purpose synonym dictionary and identifies one or more English synonyms (e.g., Hi) meaning “hello” and Chinese synonyms (e.g., [symbol] ) meaning “hello”. The display control unit 24 displays the acquired synonyms of these languages on the operation guide 500 (S86).

The operation receiving unit 27 receives the selection of the character string from the list 354, and the display control unit 24 displays the selected character string on the screen (S87).

As described above, the display apparatus 2 displays synonyms in the plurality of languages so as to enhance the possibility of displaying a character string that the user intended to select. Unlike FIG. 9, it is not necessary for the display apparatus 2 to display the target language.

### Example of User Interface

A description is given of several design examples of the operation guide.

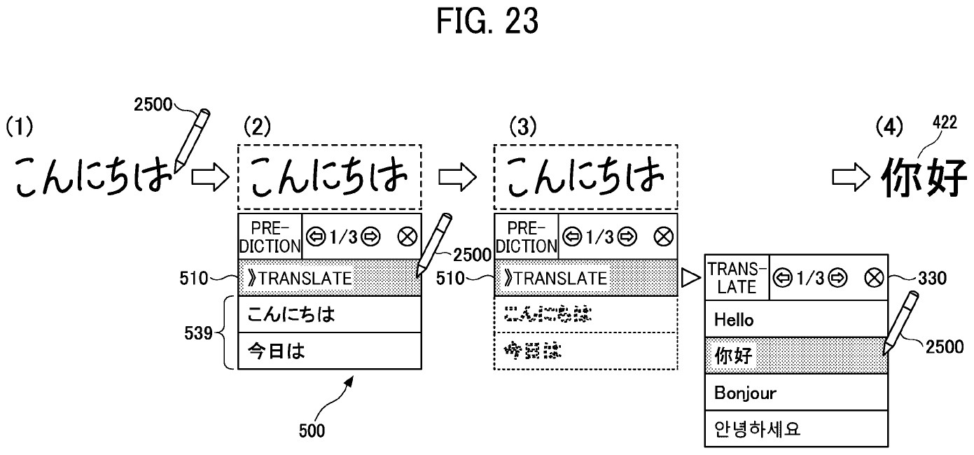

FIG. 23 is a diagram illustrating a recommendation window additionally displayed from the operation guide.

In FIG. 23, in the operation (2), the operation command candidate 510 “translate” displayed on the operation guide 500 is selected. The display control unit 24 keeps the selection result of the user in the operation guide 500 and separately displays a recommendation window 330. On the recommendation window 330, character strings of other languages synonymous with “hello” are displayed.

Such a user interface enables the user to check his or her selection history.

FIG. 24 illustrates the operation guide 500 in which the display apparatus 2 moves selectable candidates 530 from the left to the right. In FIG. 24, the operation command candidate 510 “ [symbol] [symbol] ” (Japanese meaning “translate to English and Chinese”) is not accommodated in one grid. The display control unit 24 gradually moves “ [symbol] [symbol] ” from the left to the right so that the user can read the whole operation command.

Such control uses space efficiently, for example, when an operation command or character string to be presented is long.

As described above, the display apparatus 2 according to the present embodiment provides easy-to-use user interface that simultaneously displays a plurality of target languages, for example.

### Embodiment 4

In the following embodiments, examples of configuration of a display system will be described.

A description is given below of an example of the configuration of the display system. Although the display apparatus 2 according to the present embodiment is described as that having a large touch panel, the display apparatus 2 is not limited thereto.

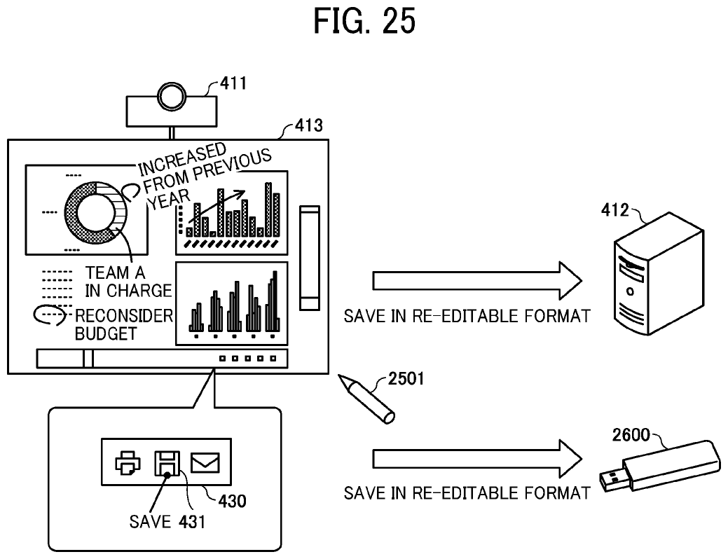

FIG. 25 is a diagram illustrating an example of the configuration of the display system according to Embodiment 4. The display system includes a projector 411, a whiteboard 413, and a server 412, which are communicable via a network. In the example of FIG. 25, the projector 411 is installed on the upper side of the whiteboard 413, which is a general whiteboard (standard whiteboard). The projector 411 mainly operates as the display apparatus 2 described above. The projector 411 is a general-purpose projector, but installed with software that causes the projector 411 to function as the functional units illustrated in FIG. 4 or 10. The “standard whiteboard” (the whiteboard 413) is not a flat panel display integral with a touch panel, but is a whiteboard to which a user directly handwrites information with a marker. Note that the whiteboard may be a blackboard, and may be simply a plane having an area large enough to project an image.

The projector 411 employs an ultra short-throw optical system and projects an image (video) with reduced distortion from a distance of about 10 cm to the whiteboard 413. This video may be transmitted from a computer (e.g., PC) connected wirelessly or by wire, or may be stored in the projector 411.

The user performs handwriting on the whiteboard 413 using a dedicated electronic pen 2501. The electronic pen 2501 includes a light-emitting element, for example, at a tip thereof. When a user presses the electronic pen 2501 against the whiteboard 413 for handwriting, a switch is turned on, and the light-emitting element emits light. The wavelength of the light from the light-emitting element is near-infrared or infrared, which is invisible to the user's eyes. The projector 411 includes a camera. The projector 411 captures, with the camera, an image of the light-emitting element, analyzes the image, and determines the direction of the electronic pen 2501. Further, the electronic pen 2501 emits a sound wave in addition to the light, and the projector 411 calculates a distance based on an arrival time of the sound wave. The projector 411 determines the position of the electronic pen 2501 based on the direction and the distance. Handwritten data is drawn (projected) at the position of the electronic pen 2501.

The projector 411 projects a menu 430. When the user presses a button of the menu 430 with the electronic pen 2501, the projector 411 determines the pressed button based on the position of the electronic pen 2501 and the ON signal of the switch. For example, when a save button 431 is pressed, handwritten data (coordinate point sequence) input by the user is saved in the projector 411. The projector 411 stores handwritten information in the predetermined server 412, a USB memory 2600, or the like. Handwritten information is stored for each page. Handwritten information is stored not as image data but as coordinates (as handwritten data), and the user can re-edit the handwritten information. However, in the present embodiment, an operation command can be called by handwriting, and the menu 430 does not have to be displayed.

### Embodiment 5

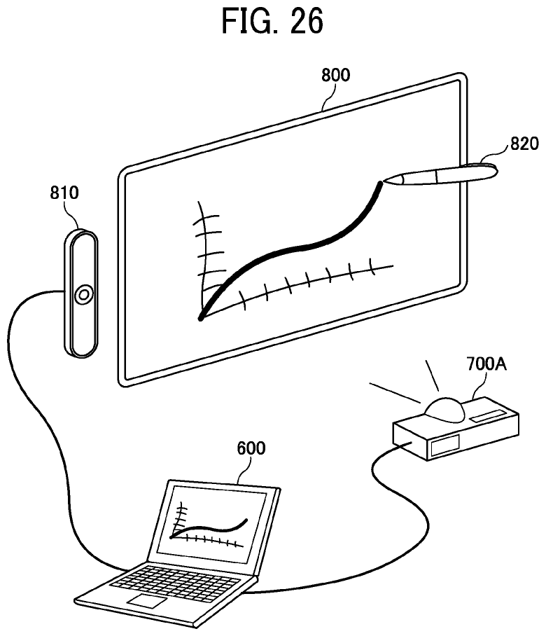

A description is given below of another example of the configuration of the display apparatus. FIG. 26 is a diagram illustrating an example of the configuration of the display system according to Embodiment 5. In the example illustrated FIG. 26, the display system includes a terminal 600 (e.g., a PC), an image projector 700A, and a pen motion detector 810.

The terminal 600 is wired to the image projector 700A and the pen motion detector 810. The image projector 700A projects an image onto a screen 800 according to data input from the terminal 600.

The pen motion detector 810 communicates with an electronic pen 820 to detect a motion of the electronic pen 820 in the vicinity of the screen 800. More specifically, the pen motion detector 810 detects coordinate information indicating the position pointed by the electronic pen 820 on the screen 800 and transmits the coordinates to the terminal 600. The detection method may be similar to that of FIG. 25. Thus, the contact position detection unit 21 is implemented by the pen motion detector 810.

Based on the coordinate information received from the pen motion detector 810, the terminal 600 generates image data based on handwritten data input by the electronic pen 820 and causes the image projector 700A to project, on the screen 800, an image based on the handwritten data.

The terminal 600 generates data of a superimposed image in which an image based on handwritten data input by the electronic pen 820 is superimposed on the background image projected by the image projector 700A.

### Embodiment 6

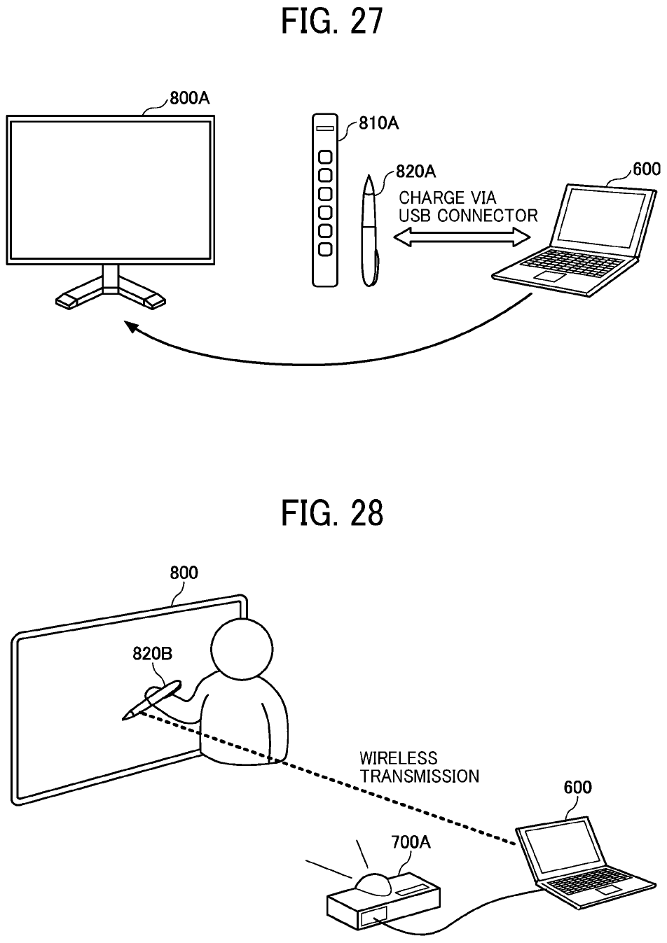

A description is given below of another example of the configuration of the display apparatus. FIG. 27 is a diagram illustrating an example of the configuration of the display system according to Embodiment 6. In the example illustrated FIG. 27, the display system includes the terminal 600, a display 800A, and a pen motion detector 810A.

The pen motion detector 810 is disposed in the vicinity of the display 800A. The pen motion detector 810 detects coordinate information indicating a position pointed by an electronic pen 820A on the display 800A and transmits the coordinate information to the terminal 600. The coordinate information may be detected in a method similar to that of FIG. 25. In the example illustrated FIG. 27, the electronic pen 820A may be charged from the terminal 600 via a USB connector.

Based on the coordinate information received from the pen motion detector 810, the terminal 600 generates image data of handwritten data input by the electronic pen 820A and displays an image based on the handwritten data on the display 800A.

### Embodiment 7

A description is given below of another example of the configuration of the display system. FIG. 28 is a diagram illustrating an example of the configuration of the display system according to Embodiment 7. In the example illustrated FIG. 28, the display system includes the terminal 600 and the image projector 700A.

The terminal 600 communicates with an electronic pen 820B through by wireless communication such as BLUETOOTH, to receive coordinate information indicating a position pointed by the electronic pen 820B on the screen 800. The electronic pen 820B may read minute position information on the screen 800, or receive the coordinate information from the screen 800.

Based on the received coordinate information, the terminal 600 generates image data of handwritten data input by the electronic pen 820B, and causes the image projector 700A to project an image based on the handwritten data.

The terminal 600 generates data of a superimposed image in which an image based on handwritten data input by the electronic pen 820 is superimposed on the background image projected by the image projector 700A.

The embodiments described above are applied to various system configurations.

As described above, one aspect of the present disclosure provides the following display apparatus. The display apparatus displays a character string converted into a target language from handwritten data even when a user does not set a target language before inputting the handwritten data. The target language is a language into which a character string of a certain language is converted (translated) such as conversion from Japanese into English. In a display device having multilingual conversion function, it is conceivable that the user sets the target language before inputting handwritten data. According to this aspect, the display apparatus obviates the user's setting a target language before inputting handwritten data.

Various aspects of the present disclosure are described below.

### Aspect A

A display apparatus includes a receiving unit to receive an input of handwritten data; a display control unit to display a plurality of different languages (i.e., language names as language options) in response to receiving of the handwritten data by the receiving unit; and a selection receiving unit to receive selection of one or more languages from the plurality of different languages displayed by the display control unit.

The display control unit displays a character string converted, from the handwritten data, into the language selected by the selection receiving unit.

### Aspect B

The display apparatus according to Aspect A includes a character recognition unit to convert, into a character string, the handwritten data received by the receiving unit.

Further, the display control unit simultaneously displays an operation command and the character string obtained by character recognition, performed by the character recognition unit, of the handwritten data received by the receiving unit. The operation command is for receiving conversion into a character string of the selected language, associated with the character string converted by the character recognition unit.

When selection of the operation command is received, the display control unit displays the plurality of different languages.

### Aspect C

In the display apparatus according to Aspect B, the display control unit displays a plurality of character strings converted from the handwritten data, in the language received by the selection receiving unit, and the display control unit displays the character string received by the selection receiving unit.

### Aspect D

In the display apparatus according to Aspect C, when the selection receiving unit receives selection of the operation command, the display control unit displays character strings obtained by converting into a plurality of languages the handwritten data received by the receiving unit, and
the display control unit displays the character string selected by the selection unit.

### Aspect E

In the display apparatus according to Aspect D, when the selection receiving unit receives selection of the operation command, the display control unit displays character strings obtained by converting, into a plurality of different languages, the handwritten data received by the receiving unit, and the display control unit further displays a plurality of character strings in one of the different languages.

The display control unit displays the character string received by the selection receiving unit.

### Aspect F

In the display apparatus according to Aspect E, when the selection receiving unit receives selection of the operation command, the display control unit displays the character strings converted in the plurality of different languages from the handwritten data received by the receiving unit, and keeps displaying the operation command.

### Aspect G

In the display apparatus according to Aspect F, the display control unit displays an operation command and the character string obtained by character recognition, performed by the character recognition unit, of the handwritten data received by the receiving unit. The operation command is for receiving conversion into a character string of the selected language, associated with the character string converted by the character recognition unit. The display control unit displays the operation command and the character string while moving the operation command and the character string in grids, respectively.

Now, descriptions are given of other application of the embodiments described above. The present disclosure is not limited to the details of the embodiments described above, and various modifications and improvements are possible.

The display apparatus 2 stores the character string as one or more character codes and stores the handwritten data as coordinate point data. The character string and the handwritten data can be saved in various types of storage media or in a memory on a network, to be downloaded from the display apparatus 2 to be reused later. The display apparatus 2 to reuse the data may be any display apparatus and may be a general information processing device. This allows a user to continue a conference or the like by reproducing the handwritten content on different display apparatuses 2.

In the description above, an electronic whiteboard is described as an example of the display apparatus 2, but this is not limiting. A device having a substantially the same functions as the electronic whiteboard may be referred to as an electronic information board, an interactive board, or the like. The present disclosure is applicable to any information processing apparatus with a touch panel. Examples of the information processing apparatus with a touch panel include, but not limited to, a projector (PJ), a data output device such as a digital signage, a head up display (HUD), an industrial machine, an imaging device such as a digital camera, a sound collecting device, a medical device, a network home appliance, a laptop computer, a mobile phone, a smartphone, a tablet terminal, a game console, a personal digital assistant (PDA), a wearable PC, and a desktop PC.

Further, in the embodiments described above, the display apparatus 2 detects the coordinates of the tip of the pen with the touch panel. However, the display apparatus 2 may detect the coordinates of the pen tip using ultrasonic waves. For example, the pen emits an ultrasonic wave in addition to the light, and the display apparatus 2 calculates a distance based on an arrival time of the sound wave. The display apparatus 2 determines the position of the pen based on the direction and the distance. The projector draws (projects) the trajectory of the pen based on stroke data.

In the block diagram such as FIG. 4, functional units are divided into blocks in accordance with main functions of the display apparatus 2, in order to facilitate understanding the operation by the display apparatus 2. Each processing unit or each specific name of the processing unit is not to limit a scope of the present disclosure. A process implemented by the display apparatus 2 may be divided into a larger number of processing units depending on the content of the processing. In addition, such division can be such that a single processing unit includes a plurality of processes.

A part of the processing performed by the display apparatus 2 may be performed by a server connected to the display apparatus 2 via a network. The synonym dictionary 31, the defined control data storage unit 32, and the input data storage unit 33 may be stored in one or more servers.

For example, the conversion unit 28 may reside on the server, which may be implemented by one or more information processing apparatuses.

Specifically, the server implements, in one example, the functional units in FIG. 4 other than the contact position detection unit 21, the drawing data generation unit 22, the display control unit 24, the network communication unit 26, and the operation receiving unit 27. In such case, at the display apparatus 2, the contact position detection unit 21 detects coordinates of the position touched by the pen 2500. The drawing data generation unit 22 generates stroke data based on the detected coordinates. The network communication unit 26 transmits the stroke data to the server. At the server, the character recognition unit 23 performs character recognition processing on the stroke data, received, to convert the stroke data into one or more character codes. The conversion unit 28 converts a character string, which is the character codes, into a character string in one or more different languages. The server then transmits the character strings of different languages to the display apparatus 2. The display control unit 24 displays, on the display, the character storing of different languages.

The drawing data generation unit 22 may be provided at the server, if the server is capable of processing coordinate data.

Further, the functions of the conversion unit 28 may be distributed over a plurality of apparatuses. For example, processing of determining a language of the character string as a target language may be performed at the display apparatus 2, while converting (translating) from input language to the target language may be performed at the server.

Further, each of the functions of the described embodiments may be implemented by one or more processing circuits or circuitry. Here, the processing circuit or circuitry in the present specification includes a programmed processor to execute each function by software, such as a processor implemented by an electronic circuit, and devices, such as an application specific integrated circuit (ASIC), a digital signal processor (DSP), and a field programmable gate array (FPGA), and conventional circuit modules arranged to perform the recited functions.

The contact position detection unit 21 is an example of a receiving unit. The display control unit 24 is an example of a display control unit. The operation receiving unit 27 is an example of a selection receiving unit. The character recognition unit 23 is an example of a character recognition unit.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described.

The present invention can be implemented in any convenient form, for example using dedicated hardware, or a mixture of dedicated hardware and software. The present invention may be implemented as computer software implemented by one or more networked processing apparatuses. The processing apparatuses include any suitably programmed apparatuses such as a general purpose computer, a personal digital assistant, a Wireless Application Protocol (WAP) or third-generation (3G)-compliant mobile telephone, and so on. Since the present invention can be implemented as software, each and every aspect of the present invention thus encompasses computer software implementable on a programmable device. The computer software can be provided to the programmable device using any conventional carrier medium (carrier means). The carrier medium includes a transient carrier medium such as an electrical, optical, microwave, acoustic or radio frequency signal carrying the computer code. An example of such a transient medium is a Transmission Control Protocol/Internet Protocol (TCP/IP) signal carrying computer code over an IP network, such as the Internet. The carrier medium also includes a storage medium for storing processor readable code such as a floppy disk, a hard disk, a compact disc read-only memory (CD-ROM), a magnetic tape device, or a solid state memory device.

This patent application is based on and claims priority to Japanese Patent Application No. 2021-041593, filed on Mar. 15, 2021, in the Japan Patent Office, the entire disclosure of which is hereby incorporated by reference herein.

### REFERENCE SIGNS LIST

2 Display apparatus

1-12. (canceled)

13. A display apparatus comprising:
receiving circuitry configured to receive input of handwritten data on a screen;
display control circuitry configured to simultaneously display, on a display, a plurality of character strings in different languages synonymous with a character string converted from the handwritten data; and
selection receiving circuitry configured to receive selection of a character string from the plurality of character strings in different languages, displayed as character string candidates,
wherein the display control circuitry displays, on the display, the character string received by the selection receiving circuitry in place of the handwritten data.

14. The display apparatus according to claim 13, further comprising:
conversion circuitry configured to:
determine a language of the character string having been received by the selection receiving circuitry; and
sets the determined language as a target language of conversion,
wherein the display control circuitry displays a character string converted, from another received handwritten data, into the target language.

15. The display apparatus according to claim 14,
wherein, in a case where the selection receiving circuitry receives selection of a character string in a particular language a predetermined number of times or greater in succession, the display control circuitry displays an inquiry of whether to set the particular language as the target language, and
wherein the conversion circuitry sets the particular language as the target language according to an instruction to set the target language received by the selection receiving circuitry.

16. The display apparatus according to claim 15, further comprising:
character recognition circuitry configured to convert, into a character string, the handwritten data received by the receiving circuitry,
wherein the display control circuitry displays one or more target language options associated with the character string converted by the character recognition circuitry, and
wherein the conversion circuitry converts another handwritten data received by the selection receiving circuitry, into a language selected from the one or more target language options.

17. The display apparatus according to claim 15,
wherein the display control circuitry displays a graphical representation of each of one or more target language options into which the handwritten data is to be converted, and
wherein the conversion circuitry converts the handwritten data into the target language based on selection of the graphical representation, received by the selection receiving circuitry.

18. The display apparatus according to claim 15,
wherein the display control circuitry displays a character string recognized by character recognition on the handwritten data together with a character string converted in the target language from the recognized character string.

19. The display apparatus according to claim 18, further comprising:
command detection circuitry configured to detect an operation command included in the recognized character string, referring to operation command definition data,
wherein the display control circuitry displays a combination of target languages associated with the detected operation command,
wherein the conversion circuitry converts another handwritten data received by the receiving circuitry into the combination of target languages selected by the selection receiving circuitry, and
wherein the display control circuitry displays a character string obtained by character recognition on the another handwritten data, together with character strings respectively converted in the combination of target languages from the another handwritten data.

20. A display system comprising:
the display apparatus of claim 13;
conversion circuitry configured to obtain, based on a synonym dictionary, a plurality of character strings in different languages synonymous with a character string converted from the handwritten data.

21. A display system comprising:
receiving circuitry configured to receive input of handwritten data on a screen;
conversion circuitry configured to determine, based on a synonym dictionary, a plurality of character strings in different languages synonymous with a character string converted from the handwritten data;
display control circuitry configured to display the plurality of character strings in different languages; and
selection receiving circuitry configured to receive selection of a character string from the plurality of character strings in different languages, displayed as character string candidates,
wherein the display control circuitry displays, on the display, the character string received by the selection receiving circuitry in place of the handwritten data.

22. A display method comprising:
receiving input of handwritten data;
displaying a plurality of character strings in different languages synonymous with a character string converted from the handwritten data;
receiving selection of a character string from the plurality of character strings in different languages, displayed as character string candidates; and
displaying the character string selected from the plurality of character strings in different languages, in place of the handwritten data.
